(19) United States
(12) Patent Application Publication
(10) Pub. No.: US 2011/0044786 A1
(43) Pub. Date: Feb. 24, 2011

(54) APPARATUS FOR AND METHOD OF CLAMPING AND TRIMMING A PERFECT BOUND BOOK

(75) Inventors: Jeffrey D. Marsh, Foristell, MO (US); Lynn W. Swenson, Johnsburg, IL (US)

Correspondence Address: Polster, Lieder, Woodruff & Lucchesi, L.C., 12412 Powerscourt Dr. Suite 200, St. Louis, MO, 63131-3615, US

(73) Assignee: Perfect Systems, LLC, Foristell, MO (US)

(21) Appl. No.: 12/576,923

(22) Filed: Oct. 9, 2009

Related U.S. Application Data
(60) Provisional application No. 61/234,882, filed on Aug. 18, 2009.
(60) Provisional application No. 61/234,800, filed on Aug. 18, 2009.

(51) Int. Cl. B42B 9/00; B26D 7/02

(52) U.S. Cl. 412/1; 412/16; 83/452

(57) ABSTRACT

Apparatus for trimming perfect bound books is disclosed including a clamping assembly and a shearing assembly, preferably powered by electric motors. The clamping assembly includes a fixed anvil and a clamp member movable along a clamp track toward and away from the anvil. The shear assembly includes a shear blade movable along a shear track toward and away from the anvil. Load members are mounted on the clamp track and on the shear track. The clamp assembly and the shear assembly each has an electric motor driving a linear actuator (e.g., a drive screw) which is operatively coupled to its respective load member. A spring or a pair of springs is interposed between the clamp load member and the clamp member and another spring or a pair of springs is interposed between the shear blade and the shear load member. Thus, as the clamp member engages the book and as the shear blade shears through the book and engages the anvil, further movement of the clamp member and the shear blade is prevented. Continued operation of the motors causes these springs to compress and to thus result in differential movement (lost motion) between the clamp member and the clamp load member and between the shear blade and the shear load member. Operation of the motors is terminated upon this differential motion of a predetermined magnitude being sensed.

### CROSS-REFERENCE TO RELATED APPLICATIONS

This application relates to and claims priority to U.S. Provisional Patent Application No. 61/234,800, filed on Aug. 18, 2009, and U.S. Provisional Application 61/234,882, filed on Aug. 18, 2009, and incorporates these provisional applications No. 61/234,800 and No. 61/234,882 by reference in their entirety.

### STATEMENT REGARDING FEDERALLY SPONSORED RESEARCH OR DEVELOPMENT

Not Applicable.

### BACKGROUND OF THE DISCLOSURE

In recent years, print on demand (POD) book printing, binding and trimming systems (POD book publishing systems) have been developed, such as shown in U.S. Pat. No. 7,014,182. This last-mentioned patent used one or more conventional black and white duplex laser printers for printing the text pages that constituted the book block of the POD book. A color cover for such POD books was also conventionally printed by a cover printer was married to the book block to form a perfect bound book. In recent years, advances have been made in color printers such that those skilled in the art will recognize that such modern color printers can economically used to print the text pages of a POD either in black and white, or in color.

As shown in the U.S. Pat. No. 7,014,182, such POD book publishing apparatuses were provided with a trimmer so as to trim the sides of the book to predetermined dimensions. It will be appreciated that such POD systems can print books of widely different sizes and thickness one after the other and the apparatus will automatically accommodate such different sizes and thickness. Reference can also be made to U.S. Pat. No. 6,928,914 which discloses a book trimmer utilizing an indexing clamp to move a book relative to a shear blade for trimming one side and the ends of a book. The trimmers used in such prior systems utilized a hydraulic cylinder to actuate a clamp that held the book in place for trimming and another hydraulic cylinder was used to actuate a shear blade to trim the book. However, the necessity of providing a hydraulic system within the print of demand book publishing systems meant that a hydraulic pump, a hydraulic reservoir, and the required associated hydraulic lines and valves must be provided. This added complexity and cost to the system and required substantial service to keep running. In addition, there was the possibility that the books may become soiled by hydraulic fluid. Still further, such hydraulic systems were not of compact size thus making it difficult to package the apparatus in a smaller footprint. Because many of these POD apparatus are to be operated in a retail store, library, corporate printing room, or other public place, such hydraulic book shear systems were noisy and messy to service or repair.

### SUMMARY OF THE DISCLOSURE

A mechanical shear, preferably an electrically powered shear, is disclosed for trimming one or more sides of a perfect bound book to predetermined dimensions. The book comprises a book block including a plurality of sheets of paper. One side of the book block and of the book constitutes its spine. The book has a cover adhesively bound to the spine of the book block with a front cover disposed against one face of the book block and with a back cover disposed against another face of the book block. The book has a first side parallel to the spine, and second and third sides perpendicular to the spine and perpendicular to the first side at opposite ends of the book. The shear comprises an indexing clamp holding the book along the spine of the book with the position of the book relative to the indexing clamp being established so that the margins of the book along the first, second and/or third sides of the book to be trimmed may be determined. The indexing clamp positions the book in a book clamp that holds the book while a margin of one of the sides of the book is trimmed. The book clamp comprises a stationary anvil that supports the book to be trimmed, and a book clamp member that is movable toward and away from the anvil between a retracted position in which the book may be positioned in the book clamp and a clamping position in which the book is clamped between the book clamp member and the anvil for holding the book while the book is trimmed. A shear blade is movable between a retracted position in which the blade is clear of a book clamped in the book clamp and a trimming position in which the blade engages the book so as to shear through one side of the book. The indexing clamp is rotatable about a horizontal axis and is movable in vertical and lateral direction relative to the book clamp so as to position one side of the book relative to the shear blade so that upon actuation of the blade a predetermined margin of the one side of the book will be trimmed. A mechanical drive (preferably an electric motor) is provided for effecting clamping of the book within the book clamp, and another mechanical drive (also preferably an electric motor) is provided for effecting movement of the blade between its retracted and trimming positions.

More specifically, the mechanical clamp drive comprises a rear stationary member and a clamp track, preferably a pair of spaced clamp slide rods, supported by the anvil and the rear stationary member and extending therebetween. The clamp member is mounted on the track for movement toward and away from the anvil between it's the retracted and clamping positions. The clamp drive further includes a motor (preferably an electric motor) and a drive screw (or other linear actuator) driven by the motor. The clamp drive includes a clamp load member slidably mounted on the slide track between the clamp member and the rear stationary member, with the clamp load member being operatively connected to the drive screw and with the clamp load member being resiliently operatively coupled to the clamp member for effecting movement of the clamp member between its the retracted and clamping positions upon operation of the motor.

The mechanical clamp drive further includes at least one spring resiliently interposed between the clamping member and the clamp load member so that upon operation of the motor in one direction, the clamp load member applies a load to the spring which, in turn, moves the clamp member toward its clamping position. As the clamping member engages a book positioned between the anvil and the clamping member, the book effectively prevents further movement of the clamping member toward the anvil, wherein upon continued operation of the motor in the one direction causes the spring to be loaded until the spring has applied a predetermined clamping load to the clamp member at which time operation of the motor is terminated and the drive screw is locked in place substantially maintaining the predetermined clamping load on the book. The clamp drive further includes at least one indicator member carried by the clamp member such that upon the clamp member engaging the book, the continued operation of the motor in the one direction causes differential movement (lost motion) between the clamp member and the clamp load member. A transducer (preferably a proximity switch) is provided that is responsive to a predetermined amount of differential movement of the clamp load member relative to the clamp member the switch so as to generate a signal operable to terminate operation of the motor.

Even more specifically, the above-noted mechanical blade drive includes a rear stationary member spaced from the anvil, and a shear track mounted to the anvil and to the rear stationary member and extending therebetween with the shear blade being mounted on the shear track for movement between its retraced and shearing positions. A blade carrier in which the shear blade is also mounted on the shear track and is slidable therealong. A shear load member is also mounted on the shear track between the blade carrier and the rear stationary member. The mechanical blade drive further comprises an electric motor and a drive screw rotary driven by the motor, the drive screw being operatively coupled to the shear load member so that upon operation of the motor in one direction or the other the shear load member and the shear blade are driven along the shear track toward and away from a book held by the book clamp. A spring is resiliently interposed between the blade carrier and the shear load member so that upon operation of the motor in one direction the shear load member via the spring causes the blade carrier and the blade to move along the track toward the book. Thus, as the shear load member moves the blade carrier along the shear track and as the shear blade initially contacts the book, continued movement of the motor in the one direction causes the load member to load the spring and causes the shear blade to shear the book. The anvil preferably has a compressible anvil member engageable by the shear blade as the shear blade shears through the book. An indicator member is carried by the blade carrier so that upon the blade shearing through the book and engaging the compressible anvil member continued movement of the blade is effectively stopped so that with continued operation of the motor in this one direction causes a sharp increase in load on the spring without substantial movement of the blade carrier which in turn causes the indicator member to move relative to the load member. A transducer (preferably a proximity switch) is positioned to sense the movement of the indicator member relative to the shear load member so that the transducer terminates operation of the motor in the one direction upon a predetermined amount of the relative movement of the indicator member. Preferably, actuation of the switch also reverses operation of the motor so as to move the blade to its retracted position. The shear track preferably is a pair of spaced slide rods and the spring preferably includes a pair of spaced compression springs interposed between the shear load member and the blade carrier.

A method of clamping a perfect bound book in position for being trimmed is also disclosed including positioning the book in a clamp in a predetermined position relative to a selectively actuable shear blade so that a margin along one side of the book may be trimmed by the shear blade. The clamp has a clamp member movable along a track between a retracted position in which the book may be inserted in and removed from the clamp and a clamping position in which the clamp firmly clamps the book to a fixed anvil. The clamp further has a clamp load member, a motor (preferably an electric motor), and a linear actuator drive (preferably a drive screw such as a ball screw) driven by the motor for moving the clamp load member between it's the retracted and clamping position. The clamp load member is resiliently operatively coupled to the clamp by springs or the like (preferably compression coil springs). The method further includes initiating operation of the motor for moving the clamp load member and the clamp member along the track from their retracted position toward the clamping position. Then, upon the clamp member engaging the book and upon the clamp load member applying a predetermined clamping load to the book, operation of the motor is terminated and the clamp is locked in its clamping position.

A method of shearing a perfect bound book is also disclosed where the method includes positioning the book to be trimmed in a clamp in a predetermined position relative to a selectively actuable shear blade for having a predetermined margin trimmed from the book along one side of the book. The shear blade is movable toward and away from the book along a track between a retracted position in which the book may be inserted in and removed from the clamp and a shearing position in which the shear blade shears through the book block and the cover so that the predetermined margin is trimmed from the book from one side of the book. The shear blade includes a blade carrier movable along the track, a shear load member movable along the track, a motor (preferably an electric motor), and a linear actuator driven by the motor for moving the shear load member and the shear blade between their the retracted and clamping positions. The method includes initiating operation of the motor for moving the shear load member and the shear blade carried by the blade carrier toward their shearing position. Upon the shear blade shearing the book and engaging a resilient anvil that substantially prevents further movement of the blade and upon the shear load member applying a predetermined shearing load to the clamp member, operation of the motor is reversed and the shear blade is moved toward its retracted position.

Further, after a first side of the book has been trimmed, the method further comprises initiating operation of the motor to move the clamp toward its retracted position thereby to release the book from the clamp. Then, the indexing clamp is actuated so as to turn and re-position the book so that a second side of the book may be trimmed. Then, then the book is clamped in the clamp in the manner described above. These steps may be repeated so as to trim the third side of the book.

Other objects and features of the disclosure will be in part apparent and in part pointed out hereinafter.

### BRIEF DESCRIPTION OF THE DRAWINGS

FIG. 1 is a perspective view of a print on demand (POD) book printing, binding and trimming apparatus of the present disclosure;

FIG. 2 is a perspective view of a page accumulator/fixture, which is part of the apparatus shown in FIG. 1, illustrated in its raised, page accumulation position for receiving pages printed by a page printer and for forming a book block thereon;

FIG. 3 is another perspective view of the page accumulator/fixture in its raised, page accumulation position illustrating an adhesive application station and a binding station therebelow;

FIG. 4 is another perspective view of the accumulator/fixture similar to FIG. 3 showing the accumulation a book block in the accumulator/fixture, with one edge of the book block constituting the spine engageable with a book block stop plate and with another edge in engagement with a side of the accumulator such that the book block is accurately positioned in the accumulator/fixture;

FIG. 5 is still another perspective view of the accumulator/fixture in which the book block has been clamped to the bed of the accumulator/fixture by an accumulator clamp, in which the book block stop plate has been moved to a retracted position, and in which the accumulator has been moved (rotated) to a second or vertical position in which the book block is vertical with the spine of the book extending below the fixture;

FIG. 6 is a perspective view of the adhesive application station shown in FIG. 3 having a roughener for roughening the spine of the book block and a glue pot or adhesive reservoir which contains a bath of a liquid adhesive (preferably a liquefied hot melt adhesive) and which has a rotary driven adhesive application drum or wheel partially immersed in the adhesive for applying a coating of adhesive to the spine of the book block, with the roughener and the adhesive reservoir being movable lengthwise of the spine of a book block positioned at the adhesive application station to roughen the spine and then to apply adhesive to the roughened spine;

FIG. 7 is an right end elevational view of the accumulator/fixture and book block on a somewhat enlarged scale with the spine of the book block positioned at the adhesive application station for the application of adhesive to the spine with the spine spaced from the uppermost peripheral surface of the adhesive application drum by a gap;

FIG. 8 is a perspective view of the accumulator/fixture holding the book block vertically at the binding station after adhesive has been applied to the spine, the binding station having a binding clamp engageable with a cover (shown in phantom) positioned above the binding clamp for clamping the cover to the spine and to the sides of the book block proximate the spine thereby to bind the cover to the spine of the book block;

FIG. 9 is a perspective view of the binding station with the binding clamp in its open position and with the book block being held by the accumulator/fixture clamp along the margin of the book block opposite the spine so that the accumulator/fixture may lower the bound book through the binding station so as to deliver the bound book to an indexing clamp for trimming of the margins of the book by a trimming station;

FIG. 10 is a perspective view of the trimming station with the indexing clamp holding the bound book in a known position along the spine of the book, with one edge (e.g., the major edge opposite the spine) positioned within the trimming station for having the margin along this major edge trimmed from the book by a trimming blade to a predetermined dimension;

FIG. 11 is another perspective view of the trimming station with the indexing book clamp having moved (rotated) the book from the position shown in FIG. 10 to another position in which one of the minor edges of the book is positioned within the trimming station for having a margin trimmed from this one minor edge by the trimming blade;

FIG. 12 is still another perspective view of the trimming station with the indexing book holder having moved (rotated) from the position shown in FIG. 11 to another position in which the other minor edge of the book is positioned to be lowered in the trimming station for having a margin trimmed from this other minor edge so that the finished book is of a predetermined, finished size;

FIG. 13 is a cross sectional view of the adhesive application station illustrating a rotary adhesive application drum as it is partially immersed in a reservoir or bath of liquid hot melt adhesive and illustrating a coating of adhesive coating the peripheral surface of the drum, and further illustrating a standing wave of increased thickness of the adhesive on the upper regions of the drum for application to the spine of the book block;

FIG. 14 is a rear perspective view of the trimming station having an mechanical book clamp and an mechanical shear;

FIG. 15 is a top plan view of the index clamp positioning a bound book in the book clamp and further illustrating the shear;

FIG. 16 is a perspective view of the book clamp in its retracted position, with only the drive shaft of the clamp electric motor show so as to better illustrate the construction and operation of the book clamp; and

FIG. 17 is a perspective view of the shear assembly with certain parts broken away for illustrative purposes so as to better illustrate the construction and operation of the shear.

Corresponding reference characters indicate corresponding parts throughout the several views of the drawing.

### DESCRIPTION OF PREFERRED EMBODIMENTS

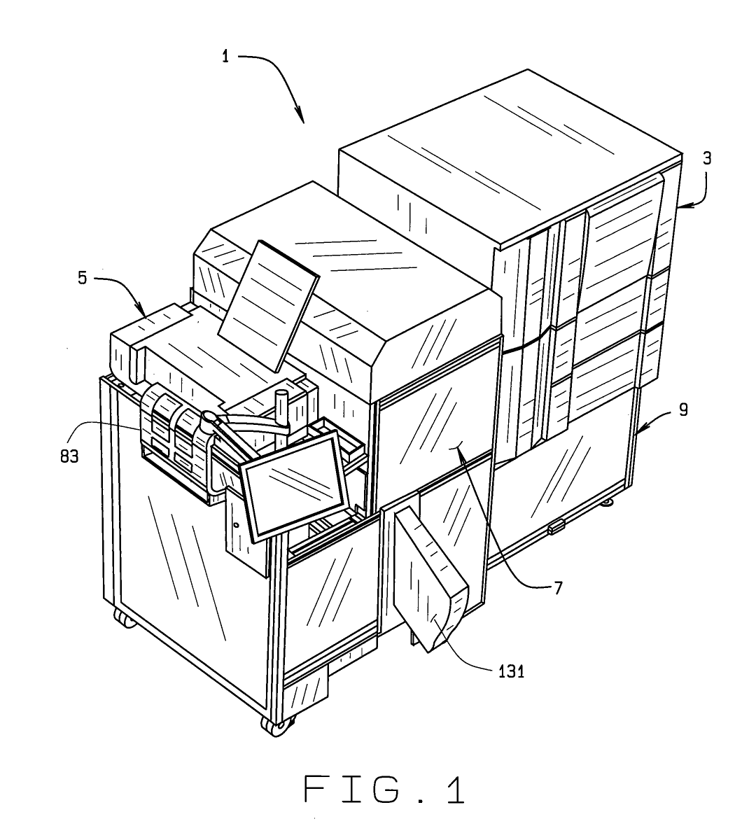

Referring now to the drawings and particularly to FIG. 1, apparatus for printing, binding and trimming print on demand (POD) books of the present disclosure is indicated in its entirety at 1. This apparatus is shown to have a text page printer 3, a cover printer 5, and a binding and trimming module 7. Page printer 3 is preferably a duplex printer capable of printing the pages of the book on one or both sides of sheets of paper. It will be understood that one or both faces of a sheet in the book block may be blank. It will be further understood that the term “paper” as used herein would include not only paper in the ordinary sense of that word, but would also include sheets made of other suitable material, such as plastic film or the like. The page printer 3 may be a black and white or a color printer. Page printers of any number of manufacturers will work satisfactorily with apparatus 1. For example, a Model ______ from Xerox Corporation, of Rochester, N.Y., or BizHub models PRO C6500 and C652 from Konica Minolta have worked well. A color cover printer is preferred. The manufacturer and model of such cover printers is not an important feature of this disclosure. Both color laser printers of various manufacturers and ink jet printers of various manufacturers have been used to print the covers for such POD books.

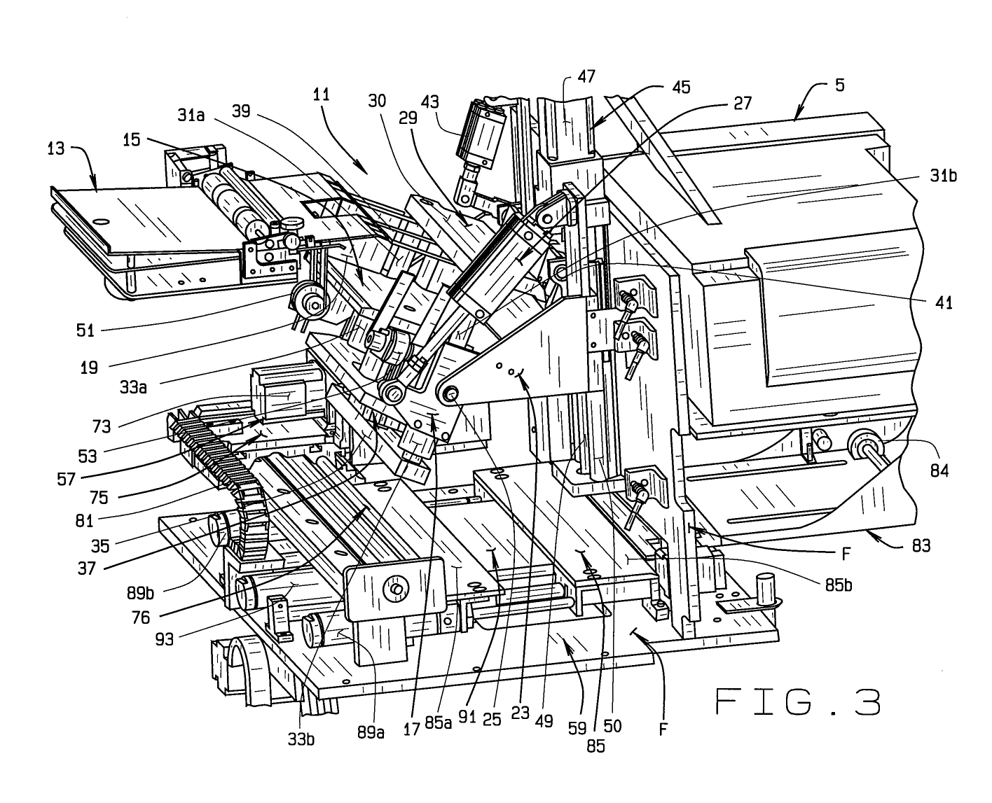

As shown, the page printer 3 is positioned on a raised platform or cart 9 of such height that the sheets printed by the page printer and ejected therefrom are at a height so that the pages enter a page de-curler 13 (as shown in FIG. 3) and are discharged into an accumulator/fixture 11 (also referred to as a carriage) where the text pages are accumulated so as to form a book block BB. It will be understood that if de-curler 13 is not needed, it may be omitted, so that the text pages may be discharged directly in the accumulator as they are ejected from the page printer. It will also be understood that if the discharge of the printed sheets from printer 3 is not at a height sufficient to match the entrance to de-curler 13, an appropriate conveyor (not shown) may be used to convey the sheets discharged from the printer to the de-curler or directly to the accumulator. As used herein, it will be understood that as the text pages of the book block BB are printed by printer 3, they are accumulated in accumulator 11 whether the de-curler is present or not.

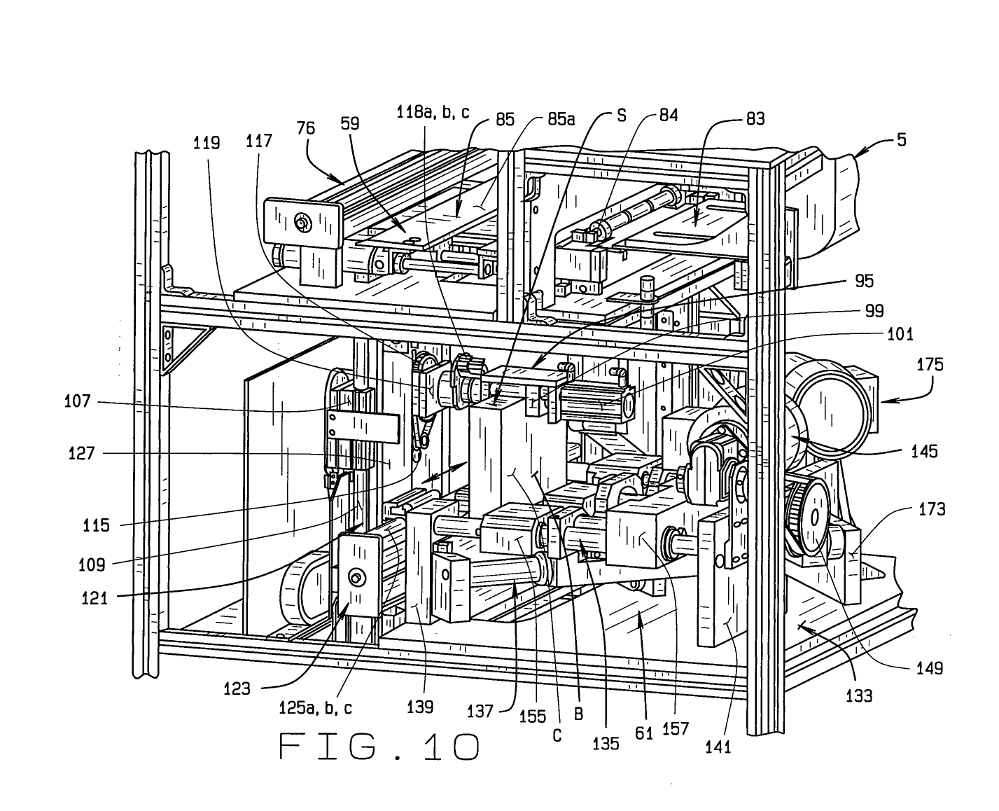

By the term “text pages” it will be understood that this refers to the pages of a book B between the front and back cover of the book whether they have text, photos, or other figures printed thereon, or whether the pages are blank. The text pages may also include the title page, the table of contents, index, and appendices. As noted, page printer 3 is preferably a duplex printer that prints on both sides of the sheets of paper that make up the book block, but a simplex may be used as well. As used herein, the terms “text page”, “page” and “sheet” may be used somewhat interchangeably, but it will be understood that generally there are only about half as many sheets of paper as there are pages in a book block BB because in a typical book block, each face of a sheet is referred to as a page. Book block BB is shown to be generally rectangular or square. As shown in FIG. 10 of U.S. Pat. No. 7,014,182, which is herein incorporated by reference in its entirety, the book block has major and minor sides with one of the major sides constituting spine S of the book block. Likewise, a perfect bound book B formed from book block BB is also rectangular. However, those skilled in the art will recognize that other polygonal shapes for a book block may be employed in accordance with this disclosure. It will be further understood that if the book block is square, the major and minor sides of such a square book block are of the same length. In such case, the spine may be along one of the sides of the square book block.

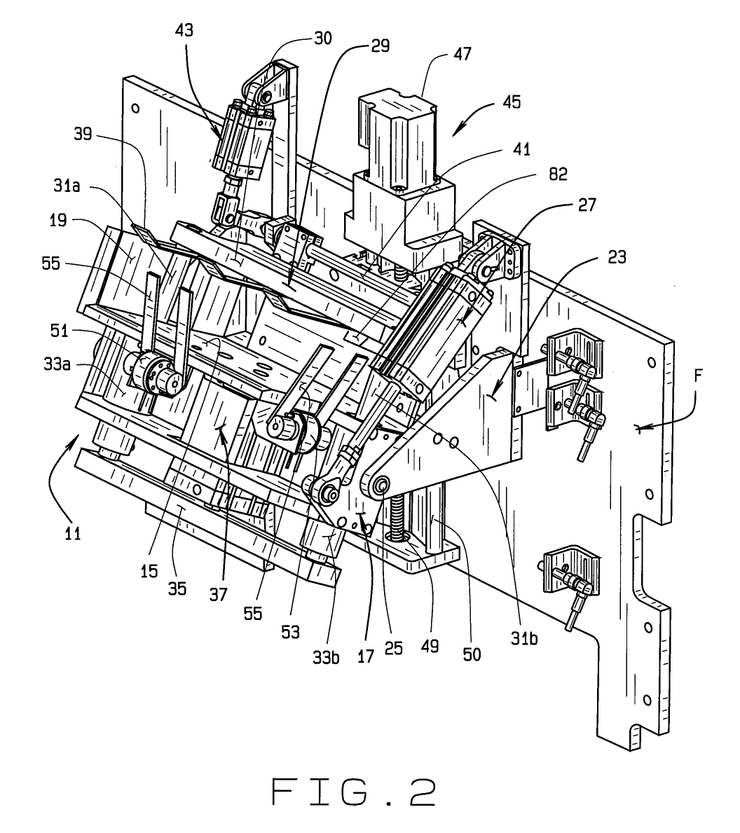

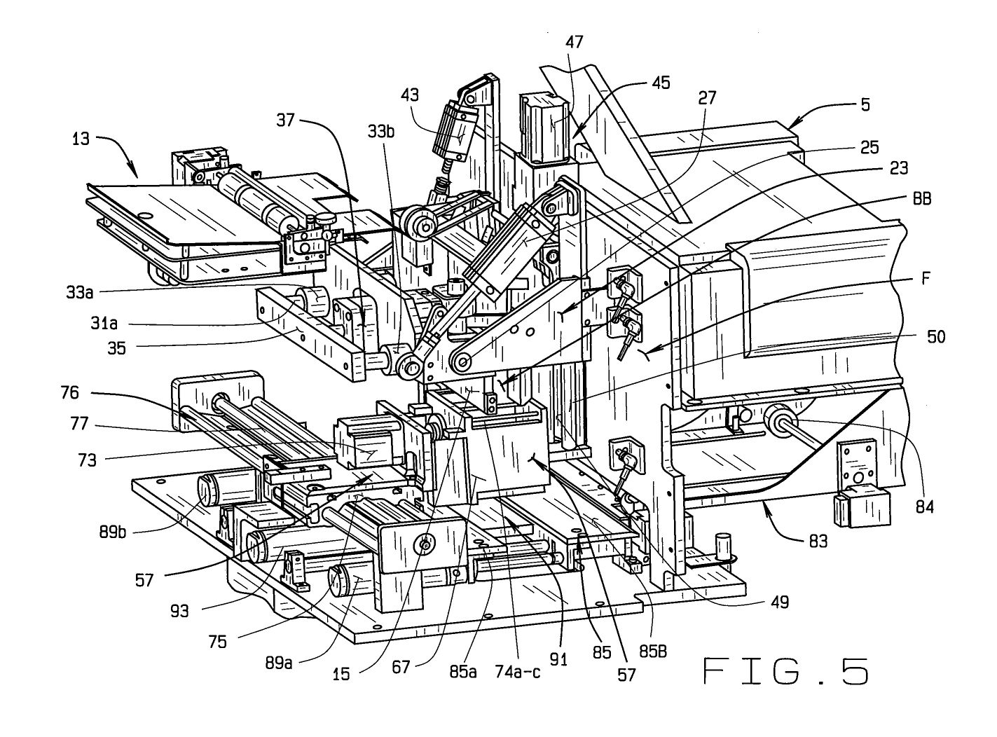

Referring now to FIGS. 2-5, the binding and trimming module 7 has a frame F upon which the major components are mounted. Specifically, module 7 has accumulator/fixture 11 mounted on this frame F. The accumulator has an accumulator bed or tray 15 upon which the text pages of the book are accumulated as they are printed by page printer 3 and either ejected directly from the printer or passed through de-curler 13 and then discharged into the accumulator. Accumulator 11 has an accumulator frame, as generally indicated at 17 in FIG. 2. The accumulator bed 15 and a side member 19 are carried by the accumulator frame with the side member extending perpendicular to the bed at one side thereof. The accumulator frame 17 carries a stop plate 21 positioned at the end of bed 15 on the opposite side of the bed from where the text pages are ejected from de-curler 13 to as to provide a stop for the pages. Stop plate 21 is pivotally mounted with respect to accumulator frame 17 for movement between a first position (as shown in FIG. 2) in which the stop plate is positioned to be engaged by the edge of each text page (or sheet) as the pages are discharged or deposited into the accumulator and a retracted position (as shown in FIG. 5) in which the stop plate is clear of the one edge of the book block BB, this one edge constituting the book block spine S. With the stop plate in its retracted position and with the book block clamped to bed 15 (in the manner as will be described), the accumulator frame 17 may be rotated from its inclined position (as shown in FIGS. 2-4) to a vertical position (as shown in FIG. 5).

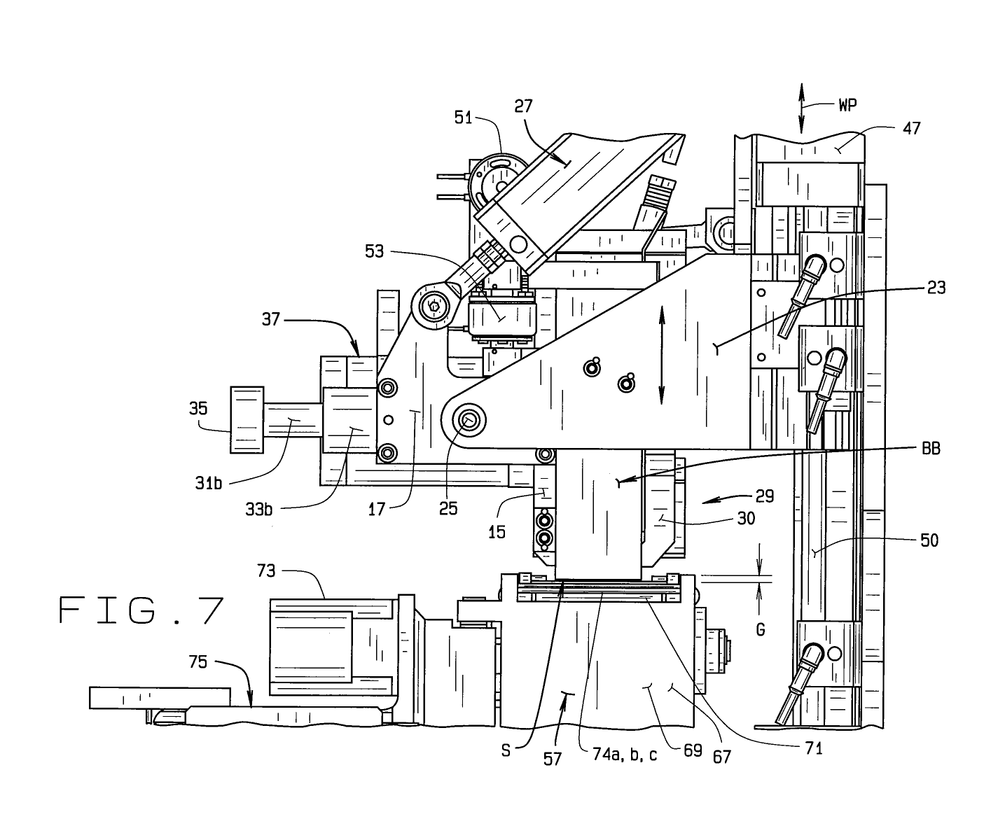

More specifically, accumulator frame 17 is pivotally mounted within an accumulator mounting frame 23 for pivotal movement about pivot points 25 between the above-described first or inclined position (as shown in FIGS. 2-4) in which the accumulator (and particularly bed 15) is in position to receive and to accumulate the pages making up the book block BB., and a second or vertical position (as shown in FIGS. 5 and 7) in which the book block BB carried by the accumulator is in a generally vertical position for purposes as will appear. The accumulator frame 17 is moved between its first and second position by means of a fluid cylinder 27, preferably a pneumatic cylinder.

As generally indicated at 29, accumulator 11 is provided with an accumulator clamp for positively holding (clamping) the book block BB relative to the accumulator bed 15 as the accumulator rotates from its first to its second position. This accumulator clamp 29 is sometimes referred to as a first clamp and it holds the book block BB in a predetermined position on bed 15 as the book block is transported to other stations along a work path WP, as indicated by an arrow in FIG. 7 and as will be described below.

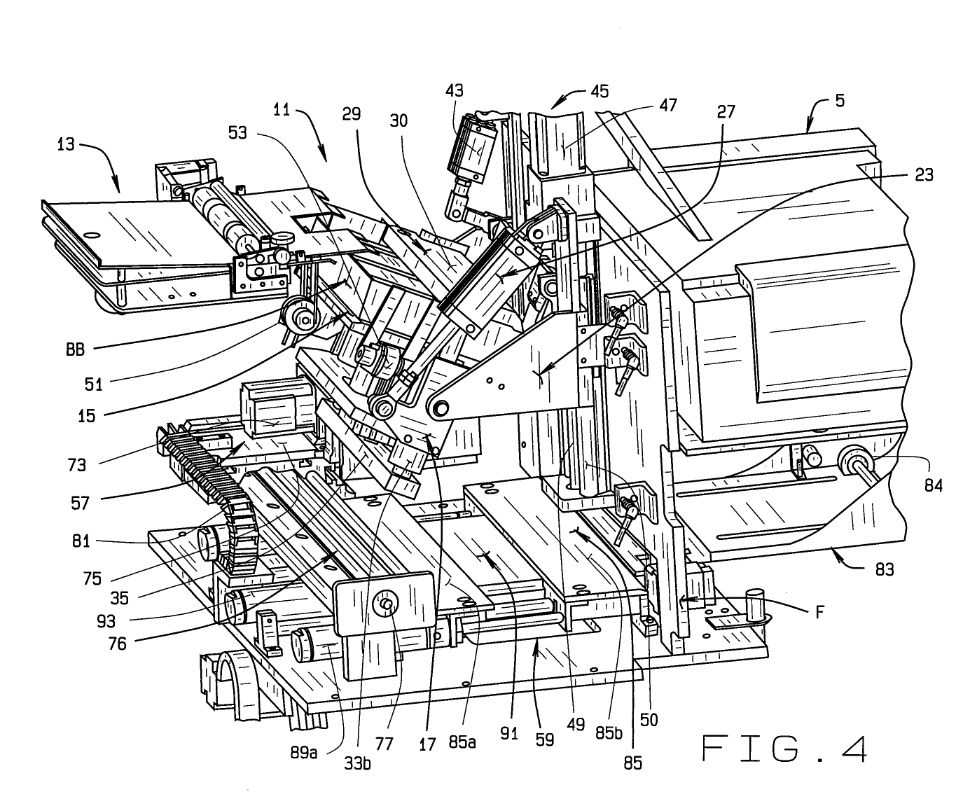

Accumulator clamp 29 includes a clamp plate 30 engageable with the upper face of the book block BB when the accumulator is in its inclined position (as shown in FIG. 4) so as to firmly clamp the book block to bed 15. The accumulator clamp includes a track, preferably slide rods 31a, 31b (as best shown in FIG. 2), at each end of clamp bar 30. These slide rods are slidably received in respective guides 33a, 33b mounted to accumulator frame 17 for slidable movement of the clamp plate 30 relative to bed 15 between its open retracted position (as shown in FIGS. 2 and 3) in which the text pages are free to accumulate on bed 15 and its closed, clamping position (as shown in FIGS. 4, 5, and 7) in which the book block is firmly clamped to the bed. As best shown in FIG. 7, the spine S of the book block BB extends out beyond bed 15 and out beyond clamp plate 30 a short distance (e.g., about ⅜ inch or 9.5 mm.) so as to expose the spine for having adhesive applied thereto and to allow the spine to be adhesively bound to the cover. The outer ends of slide bars 31a, 31b are mounted to a cross bar 35. Clamp member 30 is moved from its open or retracted position to its closed clamping position by means of a fluid cylinder 37 mounted between bed 17 and cross bar 35 so that upon actuation of cylinder 37 so as to extend its actuator rod 38 (as best shown in FIG. 4), the cross bar is caused to move away from bed 17 which in turn forcibly moves the clamp member 30 toward the bed via slides 33a, 33b sliding along slide rods 31a, 31b. In this manner, the book block is firmly clamped by clamp member 30 to bed 15.

It will be understood that when accumulator stop plate 21 is in its stop position and as the pages are discharged into the accumulator/fixture 11, the leading edges of the pages will engage the stop plate and this the stop plate will determine the position of one edge (the spine S) of book block BB relative to the accumulator. As shown in FIG. 2, page guide fingers 39 are carried by clamp member 30 so as to insure that as the text pages are discharged into accumulator/fixture 11, the pages will be directed to be between the last placed page of the book block BB and the underside of the clamp member.

As previously noted, stop plate 21 is mounted for pivotal movement relative to bed 15 between an operative position in which the stop plate is in position to be engaged by an edge of each page of the book block BB as the pages are ejected from de-curler 13 into accumulator 11 and a retracted position (as shown in FIG. 5) in which the stop plate is clear of the spine of the book block. As best illustrated in FIG. 2, the stop plate 21 is carried on a rotatable shaft 41 which in turn is rotated by a fluid cylinder 43 (preferably an air cylinder) to selectively move the stop plate between its operative and retracted positions. Specifically, upon extending the actuator rod of cylinder 43, shaft 41 is forced to rotate the stop plate way from bed 15 thereby to expose spine S.

As generally indicated at 45, a drive is provided for moving accumulator/fixture 11 in a vertical direction from a first position, as shown in FIGS. 2-4, in which the bed 15 of the accumulator may be in its inclined position and/or in which bed 15 may be moved to its vertical position with book block BB held in place on the bed by accumulator clamp 29 to a first lowered position, as shown in FIGS. 5 and 7, in which the exposed spine S of the book block is positioned to have adhesive applied thereto at an adhesive application station 57, as will be described hereinafter. Still further, continued operation of drive 45 will lower the book block from the adhesive application station to a binding station, as indicated at 59. After binding, drive 45 may be further operated so as to lower the now bound book B from the binding station to a trimming station 61. This above-described vertical movement of the accumulator or carriage 11 constitutes the work path WP (as illustrated in FIG. 7) that has the above-noted stations therealong. This will be described in greater detail below.

Drive 45 includes a drive 47 (preferably a stepper gearmotor) that rotates a vertically disposed drive screw 49, which threadably engages accumulator frame 23 and thus effects vertical movement of the accumulator/fixture 11 along at least a portion of workpath WP. More specifically, upon operation of motor 47 in one direction, the drive screw moves the accumulator frame 23, the accumulator 11, and the book block BB held therein downwardly along the work path WP, and operation of the motor in the opposite direction moves the accumulator upwardly. Of course, upon de-energization of motor 47, the accumulator and the book block held thereby are effectively held stationary at any position along the workpath. Those skilled in the art will recognize that the weight of the accumulator on drive screw 49 is not sufficient to backdrive the motor thus locking the accumulator in place along the track 50. As indicated at 50, a vertical track is provided for accumulator mounting frame 23 for vertical movement along the workpath.

As best shown in FIG. 2, a page tapper 51 is provided for tapping each sheet (or small groups of sheets) delivered to the accumulator 11 so as to tap each sheet toward stop plate 21. Another page tapper 53 is provided to tap each sheet in sideways direction toward the fixed accumulator side 19. These tappers thus insure that each sheet (or group of sheets) of the book block BB is properly and evenly positioned on bed 15. With the sheets making up book block BB firmly against the stop plate and against the accumulator side, the book block is accurately positioned in accumulator 11 in a known position. Of course, with the book block in a known position in the accumulator, a computer control system CS of the apparatus also “knows” the position of the text printed on the pages and thus “knows” how much of the margins of the bound book must be trimmed to produce a trimmed book of a predetermined finished size. This known position of the book block BB is maintained by the accumulator clamp 29 as the book block is moved from the accumulator 11 in the position as shown in FIG. 2 to the adhesive application station 57 and then is moved to a the binding station or table 59. Further, in a manner as will be disclosed, the known position of the bound book is maintained in the trimming station so that the book may be trimmed to a predetermined finished size. The computer control system CS is not shown in the drawings, but it will be understood that such a computer control system may perform many of the functions described in the above-noted U.S. Pat. No. 7,014,182, which is herein incorporated by reference in its entirety. This computer control system may be mounted at any convenient location within apparatus 1. A preferred computer control system CS may be a programmable logic controller (PLC), such as a model IC200UDD064 VersaMax Micro PLC commercially available from GE Fanuc of Charlottesville, Va.

Tappers 51 and 53 are of similar construction and operation. These tappers comprise fingers 55 carried by a rotary solenoid motor energized after each sheet (or small group of sheets) has been delivered to the accumulator the fingers tap each sheet toward stop plate 21 and toward side 19 so as to insure all of the pages in book block BB are properly positioned relative to one another and to insure that none of the sheets of the book block hang up or are uneven. In this way, it is insured that as each sheet or each group of sheets or pages are deposited in the accumulator, these last deposited pages can be readily moved relative to the accumulator and to the previously deposited pages so that all of the pages of the book block BB are accurately positioned in known positions relative to side plate 19 and stop plate 21. It will be further understood that these tappers will overcome any static electricity charges carried by the pages so that the pages of the book block are uniformly arranged relative to one another and relative to the side plate and stop plate of the accumulator so that all pages of the book block are accurately positioned in the accumulator.

It will be appreciated that the apparatus 1 may print, bind and trim a wide range of book sizes and thickness within a limited range. For example, the pages of the book block are preferably printed on a standard size sheets of a suitable paper (e.g., 8½×11, A4, or the like) in known locations on the sheets such that the excess margins of the sheets may be determined by the computer control system CS and such that these excess margins may be trimmed at a trimming station 61 so as to produce a finished book of a predetermined size. For example, in the printing of a typical book block, the matter to be printed will be centered heightwise relative to the spine (e.g., one of the major sides of the sheets) and spaced a short distance (one half of the gutter of the printed book, i.e., the blank space between facing pages of the book) from the major side that will constitute the spine S of the book block BB. In this manner, the margins along the major side of the book block opposite spine S and the margins along the top and bottom side of the book block may be readily calculated by the computer control system CS so that the book may be trimmed to have a predetermined finished dimension. In addition, books of a wide range of thicknesses may be printed, bound, and trimmed by the apparatus 1 preferably ranging between about 50 pages (about 25 sheets) to about 850 pages (about 425 sheets) or more. It will also be appreciated that the size of the book and the number of pages in the book block for a particular book are part of the information regarding the printing and binding and trimming of the book given to the computer control system CS controlling operation of the apparatus.

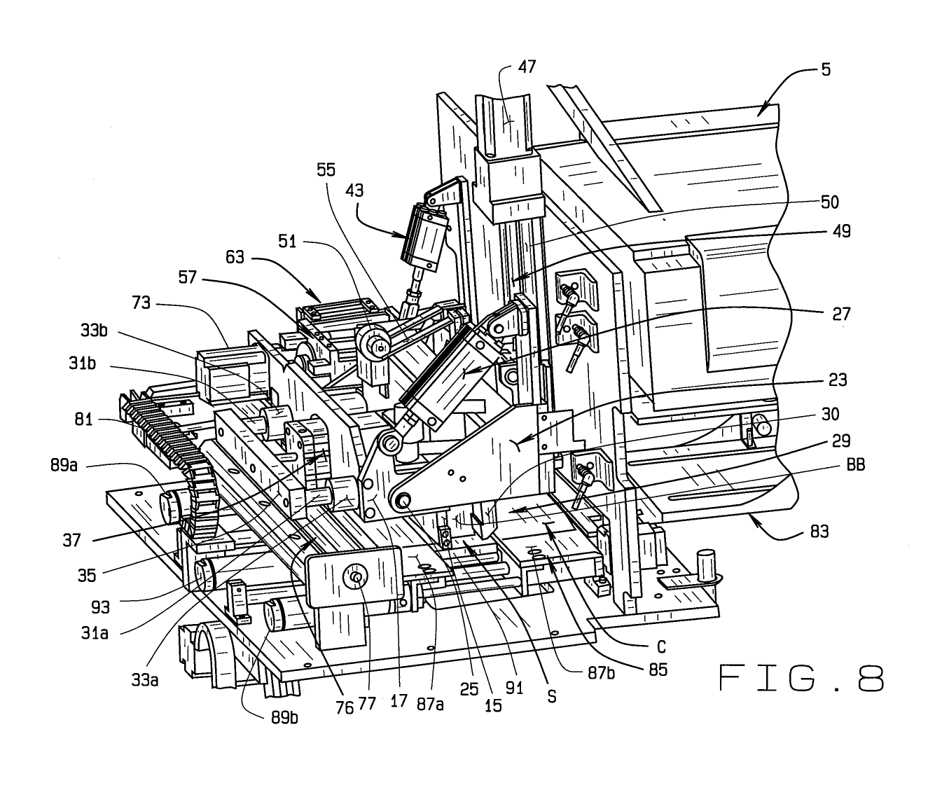

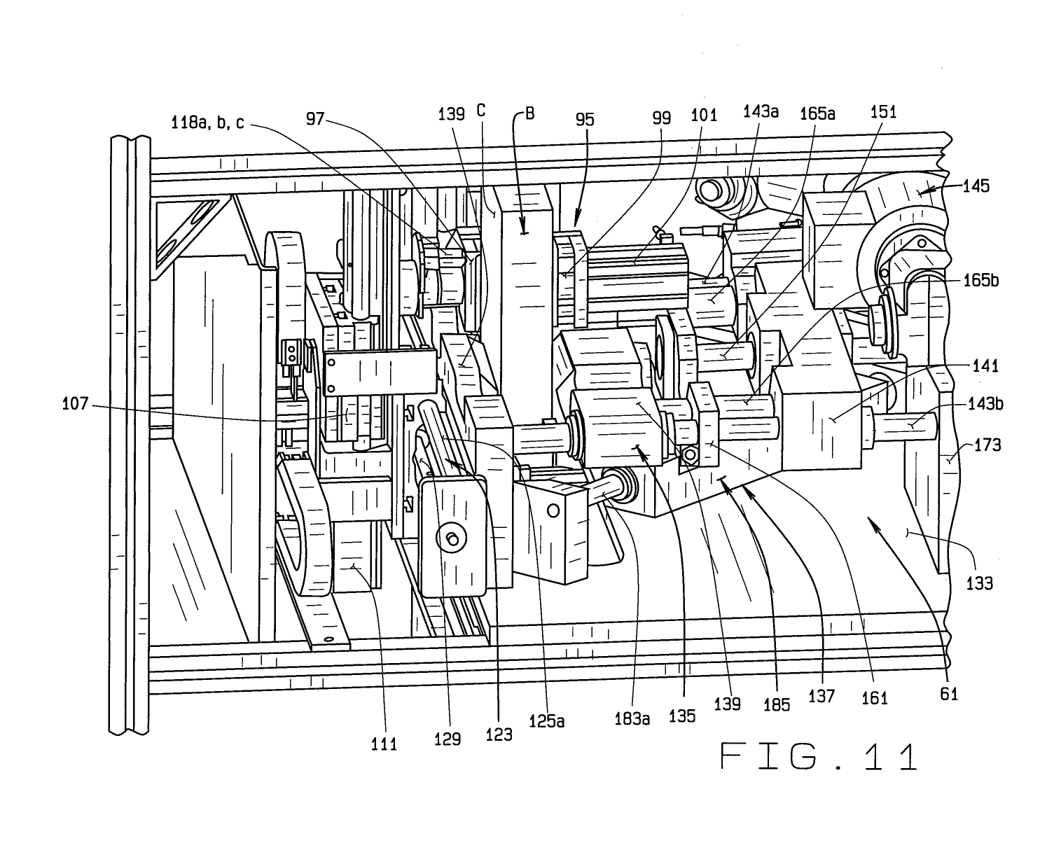

As noted, once accumulator 11 is moved from its inclined to its vertical position as shown in FIG. 4, the accumulator is movable vertically downwardly along the workpath WP toward an adhesive application station 57 below the first position of the accumulator, then to a binding station 59 below the adhesive application station (as shown in FIGS. 3-5), and then to trimming station 61 (as best illustrated in FIGS. 10-17) located generally below the binding station. At the adhesive application station 57, a suitable adhesive, preferably a liquefied hot melt adhesive is applied to spine S of the book block BB, preferably, but not necessarily, in the manner as hereinafter described. The book block is then promptly moved further downwardly to binding station 59 where a cover C (a portion of which is shown in FIG. 8) has been pre-positioned so that a desired area of the inner face of the cover, preferably the center portion of the cover, is positioned to be adhesively joined to the spine. Cover C is preferably printed in cover printer 5 while the pages of the book block are printed by page printer 3, but it will be understood that cover C may be pre-printed and delivered to apparatus as required.

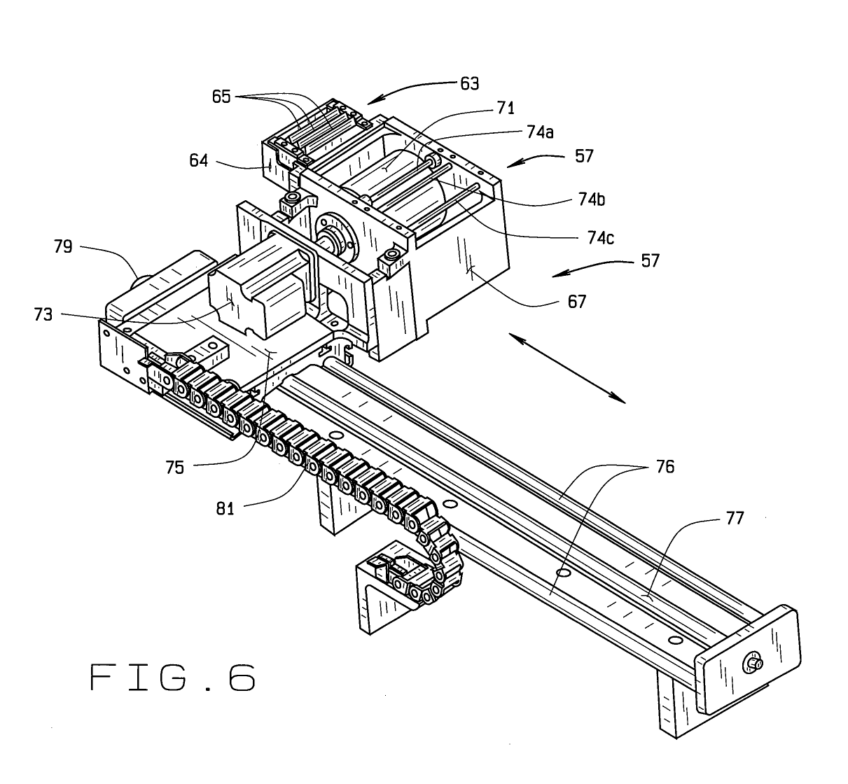

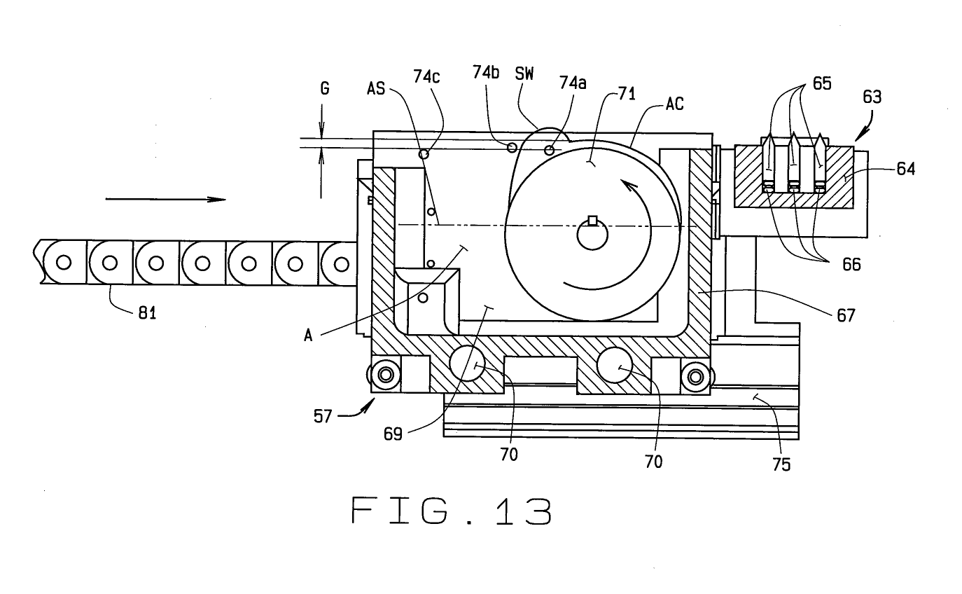

As best shown in FIGS. 6, 7 and 13, adhesive application station 57 includes a spine roughener 63 having a blade housing 64 with one or more blades 65 positioned to extend transversely to spine S. These blades are preferably sharp blades have their cutting edges facing upwardly and are biased upwardly by springs 66 (see FIG. 13) so that their cutting edges are generally coplanar, with the cutting edges being disposed to firmly engage the spine of the book block as the roughener is moved lengthwise along the spine so that the blades will scrape along the length of the spine over the full width of the spine so as to roughen the edges of the paper sheets forming the book block spine. It will be appreciated that by providing stationary blades 65 for roughening the spine as the blades are moved relative to the spine, the need for an electric motor to drive the prior rotary spine milling devices, such as shown in the above-noted U.S. Pat. No. 7,014,182, has been eliminated. Advantageously, the stationary blades do not generate substantial amounts of paper residue as such prior rotary milling devices so there is less debris to be disposed. By roughening the spine prior to application of the adhesive, this better enables the liquid adhesive to wet the spine so that the adhesive will better adhere to the spine. It will be understood, however, that the rotary milling station as described in the above-noted U.S. Pat. No. 7,014,182 may be used in place of the above-described roughener 63. It will also be understood that the adhesive applicator, as described in the '182 patent, may be used in place of the adhesive application system described below.

Adhesive application station 57 further includes an adhesive reservoir (sometimes referred to as a glue pot) 69 of a size (volume) so as to contain a sufficient supply of liquefied hot melt or other adhesive A (as shown in FIG. 13) so as to bind a number of books before more adhesive must be added to the reservoir. Adhesive pot or reservoir 59 is preferably heated to an elevated temperature if a hot melt adhesive is used by means of electric resistance cartridge heaters 70 (See FIG. 13) incorporated in the reservoir and controlled by an automatic temperature control (not shown) well known to those of ordinary skill in the art. Depending on the particular hot melt adhesive used, the adhesive is heated to a temperature sufficient to melt and to liquefy the adhesive and then is maintained at a desired application temperature without undue degradation of the adhesive over an extended period of time. For example, this temperature may range as high as about 400° F. or more, depending on the particular adhesive used. One adhesive that has been satisfactory in the binding of POD books is adhesive HM8101 commercially available from Capital Adhesives of Mooresville, Ind. This adhesive is commercially available in various forms, such as briquettes or pellets, which may be added from time to time to reservoir 69 so they will be melted and thus replenish the supply of adhesive in the reservoir. As illustrated in FIG. 13, the upper surface of the adhesive A in reservoir 69, as shown in phantom and as indicated at AS, is approximately at the level of the shaft about which wheel 71 is rotated. However, it will be understood that the level of the adhesive can vary considerably. Of course, after a predetermined number of books have been bound, a warning can be sent by the computer control system CS for the operator to replenish the amount of the adhesive in the reservoir.

Adhesive application station 57 includes an adhesive application drum or wheel 71. This drum is rotatably mounted with respect to reservoir 69 for rotation about a horizontal central axis such that the lower portion of the wheel is immersed in the above-noted liquefied adhesive in the reservoir 69. The wheel 71 is rotatably driven by a variable speed drive motor 73. This motor may be energized by the computer control system CS just prior to the application of adhesive to the spine S of a book block so that as the drum rotates up out of the adhesive, its outer peripheral surface carries a coating of the liquefied adhesive AC thereon which is applied to the spine of the book block, preferably in the manner as will be described below. It is understood that because the drum is partially immersed within the heated adhesive within the reservoir, the drum is also heated to an elevated temperature and thus helps maintain the elevated temperature of the adhesive on its peripheral surface prior to application to the spine. This helps insure that the adhesive will have adequate working time to be moved from the adhesive application station to the binding station 59 so that cover C is properly adhesively bound to the spine of the book block.

As shown in FIG. 13, as drum 71 rotates up out of the adhesive in reservoir 69, the adhesive coating AC distributes itself over the peripheral surface of the drum so as to form the above-noted adhesive coating across the width of the drum and around the drum at least a portion of the periphery of the drum. At the top of the drum the adhesive coating AC encounters a first wiper bar or rod 74a extending transversely of the width of the drum and positioned somewhat closer to the drum than the adhesive thickness AS, which causes the adhesive coating for form a standing or stationary wave (or bulge) SW proximate the rod 74a, as shown in FIG. 13. This standing wave SW is a region of increased adhesive thickness at the top of drum 71 for purposes as will appear. The height of this standing wave is dependent on the speed at which the drum is rotated, the temperature of the adhesive coating, and the properties of the adhesive.

As shown in FIG. 13, after the standing wave SW flows over wiper bar 74a, the adhesive coating slumps back onto the peripheral surface of drum 71. In addition to wiper bar or rod 74a, adhesive pot 67 is provided with two additional wiper bars 74b and 74c extending from one side to the other of the adhesive pot. As noted, the first wiper bar 74a is positioned so that it will encounter the above-noted adhesive coating AC on wheel 71 so as to help form standing adhesive wave SW on the drum proximate the first wiper bar. This standing wave SW thus constitutes a “target” of increased adhesive thickness of the drum into which the spine S of the book block may be submerged to substantially uniformly coat the spine S with adhesive across the width of the spine and along its length as the adhesive station 57 is moved lengthwise along the spine. It has been found that this standing wave is stable over a usable range of wheel rotational speeds and over a range of adhesive temperatures. The second wiper bar 74b strikes off excess adhesive applied to the spine, and the third wiper bar 74c catches any drips or strings of adhesive that may extend down from the spine so as to prevent these drips from being carried to the inside face of cover C during the binding operation.

As shown in FIG. 6, adhesive application station 57 and spine roughener 63 are mounted on a carriage 75, which in turn is movable along a path or track 76 relative to a stationary book block BB and spine S held in place by the accumulator or first clamp 29 (see FIG. 7) at the binding station 59. This movement of the adhesive application station 57 and the spine roughener 63 relative to the stationary book block is shown to be carried out means of a drive screw 77 rotatably driven by a suitable reversible drive motor (preferably a stepper motor) 79, where the drive screw is threadably engaged with carriage 75. For example, motor 79 may be a stepper motor under the control of the computer control system CS of the apparatus 1. The direction of movement of the adhesive application station 57 relative to a stationary book block BB held by accumulator clamp 29 at the adhesive application station 57 for roughening the spine and for applying adhesive to the spine is shown by the arrow in FIG. 13.

Wheel or drum 71 may be driven by motor 73 in a direction (as shown by the arrow in FIG. 13) such that the top of the wheel operatively engages, but is spaced slightly below, spine S for the application of adhesive to the spine. More particularly, the upper reach of the wheel is separated from the spine by a gap G, as shown in FIG. 7, so as to apply adhesive to the spine S. As described in detail below, it has been found that by varying gap G, the amount of adhesive applied to the spine may be varied. It has also been found that by varying the gap G in relation to the thickness of the book block BB (the number of pages in the book block) different thicknesses of adhesive may be applied to thin and to thick book blocks so as to insure that books of all thicknesses within a limited range, for example books ranging between about 50 pages (about 25 sheets) and over 850 pages (425 sheets) or more, may be more uniformly bound. It will be understood that books having considerably fewer than 25 sheets are not practical to bind a cover to the spine because the spine of the book block is not sufficiently wide to make a good bond with the cover. It has been further found that books having more than about 850 pages (425 sheets) are pose problems with the resulting book being difficult for a reader to open and for the pages to remain open. However, books having fewer than 25 sheets and more than 425 sheets may be printed, bound and trimmed by apparatus 1. It has also been found that 850 pages will cover the vast majority of books to be printed.

Wheel 71 may be rotated in either direction to apply adhesive to spine S. That is, as shown in FIG. 13, wheel 71 may be rotated in counterclockwise direction (as shown by the direction of the arrow) so that the wheel “rolls” along the spine (even though the topmost surface of the wheel does not touch the spine) to apply the adhesive. In this mode of operation, the surface speed of the rotating wheel may nearly match the lineal speed at which the adhesive application station 57 is moved along track 75 relative to the stationary book block BB. This results in an even application of a coating of the adhesive on the spine.

However, it has also been found that it may be desirable that the wheel be rotated in the opposite (clockwise) direction upon movement of the adhesive application station along the track. More specifically, it has been found that if the wheel is rotated in the opposite direction (clockwise, as shown in FIG. 13), wiper rod 74a should be moved to the opposite side of the top of wheel 71 from its position shown in FIG. 13. With the wheel rotated in such clockwise direction and when the adhesive station is moved relative to the spine and when the spine first encounters the adhesive on the wheel, a large build-up of adhesive will result at the leading end of the book block spine S.

It will be appreciated that the above-noted standing wave SW formed on the periphery of wheel 71 will be so formed regardless of the direction of rotation of the wheel. When the wheel is rotated in the direction opposite to the direction of movement of the wheel relative to the stationary book block spine S and when it is desired to apply a heavy coating of adhesive to the spine, the wheel is rotated at a speed by motor 73 such that the standing wave will be formed at the upper reach of the wheel rotating into the spine in timed relation to the spine entering the adhesive application zone (e.g., the upper surface of wheel 71). This avoids the build-up the adhesive on the leading end of the spine, but allows adhesive to be applied to the spine at a faster rate than if the wheel is rotated in the direction of travel of the adhesive application station. Alternatively, this same result could be achieved by speeding up the rotation of the wheel 71 after the leading end of the spine has entered the adhesive application zone. By increasing the speed of rotation of the wheel, the height of the standing wave SW is increased. By applying adhesive to the spine at a faster rate and in an excess amount and then wiping off the excess adhesive, the adhesive will better wet the edges of the text pages making up the spine S and will better penetrate between the individual pages of the book block at the spine.

More particularly, carriage 75 on which adhesive application station 57 and spine roughener 63 are mounted is slidably movable along track 76 generally lengthwise of spine S of the book block BB from an initial position at the right-hand end of the track (as viewed in FIG. 5) in which the roughener is clear of the first end of the book block spine S to be roughened. From this initial position, the adhesive application station 57 is movable lengthwise along the entire length of the spine so that the roughener may roughen the entire length of the spine and so that the adhesive application drum 71 to apply adhesive along the entire length of the spine and across the entire width of the spine. It will be appreciated that the speed of the relative movement of the adhesive application station 57 and spine roughener 63 may be increased or decreased by varying the speed at which motor 79 and drive screw 77 are driven. Electric wires for the drum drive motor 73, the reservoir heaters 70, and any instrumentation wiring (not shown) are carried in a flexible cable tray 81 to permit the adhesive application station 57 and spine roughener 63 to be reciprocated along track 75 without damage to the wires.

As noted above, the thickness of the adhesive coating AT applied to spine S by the adhesive application station 57 may be controlled or varied by adjusting gap G (see FIG. 7) between the spine of the book block and the topmost surface of wheel 71. As noted, accumulator 11 may be moved vertically along workpath WP by drive motor 47 and drive screw 49. Motor 47 is preferably a stepper motor under the control of the computer control system CS. As previously described, because the lower edges of the paper sheets comprising the book block BB are forced against stop plate 21 by tap fingers 55 each time page tapper 51 is actuated (preferably after each sheet is deposited in the accumulator), and because accumulator clamp 29 securely holds the book block in place on the accumulator bed 15, when the accumulator has the book block in the position shown in FIG. 7, the vertical position of spine S is “known” to the computer control system.

As noted, motor 47 driving drive screw 49 is preferably a stepper gearmotor, as is readily commercially available from a number of sources. Such stepper motors are typically provided with an encoder (not shown) that has a predetermined number of counts for each revolution of the drive shaft of the motor. For example, motor 47 may have 2048 counts for each revolution of its drive shaft and for each revolution of the drive screw. Drive screw 49 is preferably a threaded lead screw (or ball screw) and as such has a known pitch (i.e., the distance between two adjacent threads). For example, drive screw 49 may have a pitch of 0.25 inches (6.35 mm.). Thus for motor 47 and for drive screw 49 in the above example, the resolution of the drive is 0.25 inches/2048 counts=0.000122 inches (0.0031 mm.) for each count. It will be understood that this is only one example of the number of counts for the stepper motor encoder and for the pitch of a particularly drive screw. Those skilled in the art will appreciate that other stepper motors, drive screws and, in fact, other linear actuators, may be used in place of motor 47 and drive screw 49 in the above example.

More particularly, using the numbers of the above example, drive 45 has a “home” position know to the computer control system CS, where this “home” position is used as a reference position for the book block as it moves along workpath WP. Thus, when the accumulator mounting frame 23 is in its fully raised position (as shown in FIGS. 2-4) in which the accumulator 11 is in its inclined position to receive the printed text pages and to form (collate) the book block BB on accumulator bed 15, the position of the mounting frame 23 relative to the home position is known to the computer control system. Likewise, the vertical position of the mounting frame is known to the computer control system at any position along track 50. Thus, the computer control system CS “knows” the position of the book block BB and of the spine S when the book block is in position at the adhesive application station 57, at the binding station 59, and at the trimming station 61. Because the book block is accurately positioned in the accumulator 11, as described above, the position of the book block and spine S are accurately known to the computer control system as the book block is moved to the various stations and can be controlled by the computer control system with great accuracy, theoretically to within about±0.000122 inches (0.0031 mm.), as shown by the above example. By adjusting the height of the spine at the adhesive application station 57, the width of gap G may be controlled. This allows for the application of adhesive to the spine to be varied in relation to the thickness of the book block, it allows the book block spine to be accurately positioned with respect to a desired position relative to the cover C at the binding station 59, and allows the position of the bound book to be accurately known to the trimming station 61 so that the margins of the book may be trimmed with good accuracy to produce a book of a known predetermined size. Because each book produced by the apparatus 1 may be of a different size and/or thickness, as compared to the next or last book to be produced, and because the computer control system CS is given information concerning the size of the book block and the number of pages in the book block, apparatus 1 has the ability to accurately control the thickness of the adhesive applied to the spine, the ability to accurately place the book block spine relative to the cover, and the ability to accurately trim the margins of the book to predetermined dimensions for the book being printed on demand, apparatus 1 has the ability to accurately print, bind and trim books in a wide variety of sizes and thicknesses one after the other in a fully automatic mode with no operator intervention.

As noted, the thickness of the coating of adhesive applied to the spine S at the adhesive application station 57 may be varied in relation to the thickness of the book block of the book then being printed and bound. It will be appreciated that a first book to be printed, bound and trimmed by apparatus 1 may be relatively thin (e.g., 100 pages or 50 sheets) and the next book may be thick (e.g., 850 pages or 425 sheets). It has been found to be desirable to vary the thickness of the adhesive applied to the spine of book blocks in relation to the thickness of the book block. This is accomplished by varying the width of gap G (as shown in FIG. 7 and in FIG. 13) between spine S and the upper reach of adhesive wheel 71 by accurately controlling the vertical position of the spine S relative to the topmost surface of wheel 71. In the example above, the spine of the book block spine is lowered by drive 45 until it is positioned a predetermined distance from its home position, which as indicated may be an arbitrary reference position, thereby to establish an initial thickness of gap G. For example, it has been found that if the position of the spine is about 68,430 counts from its home position, gap G will be such that a suitable thickness of adhesive will be applied to a thin book block (e.g., a book block having about 50 pages or about 25 sheets). It has been found that if the thickness of the adhesive coating applied to spine S is varied in accordance with the thickness of the book block or spine, a better book block-to-cover binding is accomplished. This variance of the adhesive thickness corresponding to the thickness of the book block has been found to be approximated by the relationship AT=b+mX, where AT is the adhesive thickness applied to the spine, b is a constant representing the initial position of spine S (expressed in counts) relative to the above-noted home position so as to establish a minimum width of gap G, and mX is a function of the number of pages in the book block also expressed in counts. More specifically, it has been found that if X is the number of sheets of paper in the book block (i.e., about half the number of pages in the book block) and if m=0.5, the adhesive thickness AT applied to the spine will result in the satisfactory binding of covers to books having a range of thickness between about 50 pages (about 25 sheets) and a thick book having about 850 pages (about 425 sheets). However, it will be appreciated that the numbers of the above relationship can be varied widely (e.g., plus or minus 30% or more) and still satisfactory binding of thin, thick and intermediate thickness books will result. This variance is due to differences in the adhesive used, the temperature of the adhesive, and the physical properties of the paper in the book block, primarily the wetting characteristics of the paper and the adhesive.

For example, if a book containing 500 pages (250 sheets) in its book block BB is to be bound, the number of pages (or sheets) in the book block is made known to the computer control PLC. In accordance with the above relationship, AT=b+mX, where b is an initial position (e.g., 68,430 counts), where m is a constant factor (e.g., 0.5), and where X is the number of pages in the book block, in counts. Thus, for a book having 250 pages, the adhesive thickness AT=68430+(0.5×250=125 counts)=68,555 counts. Of course, where one count=0.25 inches/2048=0.000122 inches/count, the gap G would be increased about 0.015 inches (0.38 mm.). In another example, if the thickness of the book block is 850 pages (425 sheets), the width of gap G would be increased about 0.025 inches (0.66 mm.).

Alternatively, instead of approximating the thickness of the book block BB by taking into account the number of pages or sheets in the book block and then varying the thickness of the adhesive applied to the spine S, as described above, it has been found that in certain situations it may be desirable to accurately measure the thickness of the book block to be bound after it has been firmly clamped in accumulator clamp 29. It will be appreciated that a number of factors in addition to the number of pages or sheets of paper affect the thickness of the book block. For example, the type of paper used and the humidity in the room which may cause the thickness of each sheet of paper to vary considerably may cause the actual thickness to vary considerably from the estimated thickness of the book block based solely on the number of pages in the book block.

Further, by accurately measuring the thickness of the book block, the computer control system CS will then “know” the position of the true centerline of the particular book block about to be bound. By knowing the true centerline of the spine S of the book block BB of the book about to be bound, the computer control system may adjust where the front cover image and the spine image for that specific book is printed on the cover stock by cover printer 5 so that the centerline of the spine of the cover can be accurately positioned in the binding station 59 by controlling the operation of cover conveyor 83 and conveyor rollers 84. This allows the centerline of the cover to be in register with to the true centerline of the book bock, even if the operator of the apparatus 1 would choose to use paper stock of a different thickness than is normally used, or if ambient humidity changes the thickness of the book block.

More specifically, the true thickness of the book block BB as it is clamped in accumulator clamp 29 may be determined by mounting a laser measuring device, as best shown at 82 in FIG. 2. Laser measuring device or sensor 82 is shown mounted on clamp member 30 and is targeted to accurately measure the distance between the inner face of accumulator bed 15 and the inner face of clamp member 30 after the accumulator clamp has firmly clamped a book block BB within the accumulator clamp, as has been previously described. One such laser measuring device may be a laser measurement sensor, such as an Acuity AR200-50 sensor, commercially available from Schmitt Measurement Systems, Inc. of Portland, Oreg. Of course, other such laser measuring sensors are available from other manufacturers and will work well in this application. Those skilled in the art will recognize that other devices may be used to accurately measure the thickness of the book block as it is clamped in accumulator clamp 29. One such other device that may be used in place of a laser measurement sensor is a linear variable differential transformer (not shown), which may be mounted on clamp cylinder 37 may be used to accurately determine the spacing of accumulator bed 15 and clamp member 30 and hence the thickness of the book block.

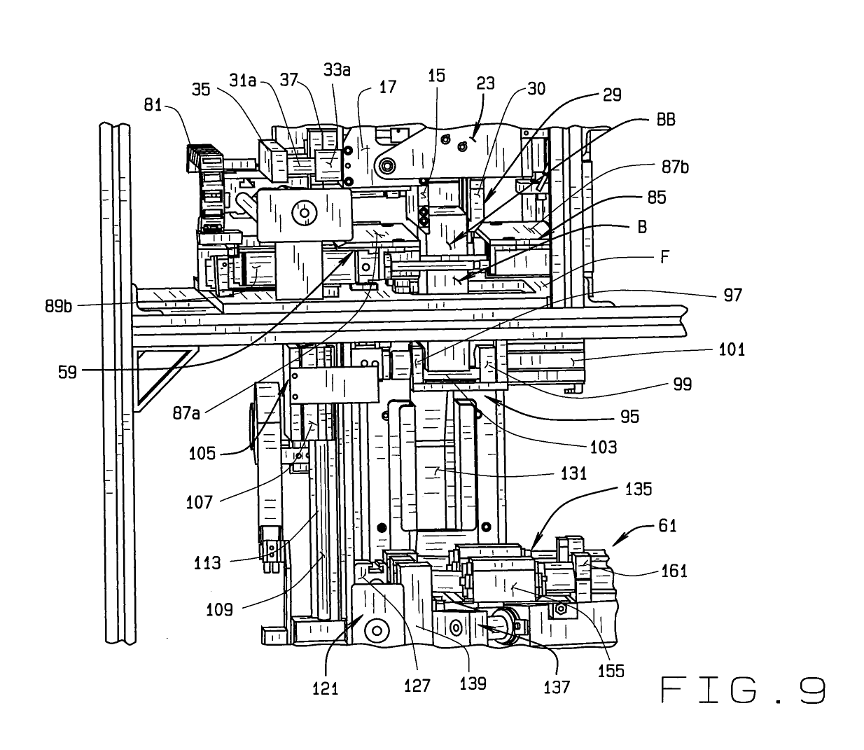

In such a system using a laser measuring sensor 82 or a linear variable differential transformer (not shown) to determine the thickness of the book block spine S and to adjust the width of gap G (as shown in FIGS. 7 and 9), the above-described relationship AT=b+mX may be employed where AT and b have the meanings discussed above, where m is a correction factor, where X is the measured thickness of the book block, and where mX is expressed in a number of counts related to the measured thickness of the book block. For example, for a book block that is measured to be 1.00 inches thick (i.e., where X=1.00 inches), m may be equal to, say, about 0.015 so that mX is equal about 123 counts. Using the above example, if b=68,430 counts and if the measured thickness of spine S=1.00 inches, then the thickness of gap G for this 1.00 inch thick book block would be increased about 123 counts, or AT=68,430+123=68,553 counts.

After adhesive is applied to spine S at the adhesive application station 57, the latter is moved to a position clear of the spine (as shown in FIG. 6), and drive 45 is initiated to move the book block BB held by clamp 29 from the adhesive application station 57 to binding station 59. It will be appreciated that a cover C for the book being printed may be printed by cover printer 5 while the page printer 3 prints the pages for the book block. Upon cover C being printed by the cover printer, the cover is delivered to the binding station or binding table 59 by means of a cover conveyor 83. Alternately, a pre-printed cover may be delivered to cover conveyor 83. This cover conveyor has power driven rollers 84 (as shown in FIG. 3) driven by motors (not shown) that in turn are under the control of computer control system CS so that the leading edge of the cover may be accurately positioned with respect to binding station 59 so as to align a desired portion of the cover (typically the center or the spine of the cover) with the spine of the book block thus enabling the spine of the book block to be joined to the cover along the predetermined area of the cover to form a bound book B.

As shown in FIG. 8, binding station or binding table 59 has a binding clamp, as generally indicated at 85, having a pair of self-centering binding clamp jaws 87a, 87b that are movable in horizontal direction perpendicular to the sides of the vertically disposed book block BB between a retracted position in which the jaws are clear of the book and a clamping position in which the jaws engage the cover C positioned at the binding station and the book block BB adjacent spine S. When in their clamping position, these clamp jaws forcibly press the cover against the sides of the book block. This in turn adhesively binds the cover to the spine to the spine of the book. The clamping jaws are moved between their retracted and clamping positions by fluid cylinders 89a, 89b, preferably air cylinders.

As indicated at 91 in FIG. 8, a retractable floor plate or bed is provided at binding station 59 below clamping jaws 87a, 87b for supporting cover C and book block spine S between the clamping jaws as the clamping jaws close on the cover and book block. During binding, floor plate 91 provides a solid surface to support the book block and the cover and gives support to the cover as the book block is moved downwardly into binding engagement with the cover. It will be understood that as accumulator clamp 29 moves the spine S of the book block BB into engagement with the center portion of cover C, the book block spine forces the cover downwardly into engagement with floor plate 91. This insures that the cover is in contact with the adhesive on the spine as the clamp jaws close. It will be appreciated that the clamp jaws 87a, 87b remain in their closed position holding the cover on place on the book block for a time sufficient (e.g., a few seconds) to allow the adhesive to set and to adhere the cover to the spine. Upon completing binding of the cover to the book block, a fluid cylinder 93 is actuated to retract bed plate 91 so as to clear a path through the binding station when clamp jaws 87a, 87b are open to permit the bound book to be conveyed downwardly to the trimming station 61 in a manner as will appear.

More specifically, upon binding of the cover to the book block and while the now bound book B is still gripped by clamp jaws 87a, 87b so as to permit the adhesive to bind the cover to the spine of the book block, accumulator clamp 29 is operated to release its grip on the book block BB proximate spine S, and drive 45 is actuated to move the accumulator clamp upwardly toward the top edge of the book block distal from the spine. There, accumulator clamp cylinder 37 is actuated so as to re-grip the book block adjacent the top edge of the book block so that as the book is re-gripped, its position is known to the computer control system CS. Then, cylinder 93 is actuated so as to retract binding floor 91, clamp jaws 87a, 87b are opened, and drive 45 is actuated so as to lower the bound book spine first between the open clamp jaws toward trimming station 61. As the bound book B is moved downwardly between the open jaws 87a, 87b, the cover will be swept inwardly toward the book block by the jaws. It will be appreciated that when the clamp 29 re-grips the book block adjacent the top edge of the book block, the position of the book block and hence of the bound book B in both heightwise and widthwise direction continues to remain known to the computer control system CS.

As shown in FIGS. 9-12, as drive 45 lowers the bound book B from the binding station 59 to the trimming station 61, the spine S of the bound book is placed in a trimming index clamp, as generally indicated at 95. As shown in FIG. 9, this clamp has a fixed clamp jaw 97 and a movable clamp jaw 99 movable toward and away from the fixed jaw by means of a fluid cylinder 101, preferably an air cylinder. Between jaws 97 and 99, a bearing surface 103 is provided against which the spine S of the bound book B will rest during the trimming operation. With the spine of the book bearing against surface 103, and with clamp 95 gripping the book along its spine, the position of the book in clamp 95 is known to the computer control system CS. Because the control system also knows the desired finished size of the book being trimmed and the margins of the book that must be trimmed from one or more sides of the book to result in the desired finished size, the computer control system thus knows the amount the margins must be trimmed from one or more sides of the book to result in the finished book to be of the desired predetermined size.

As shown in FIGS. 9-12, trim indexing clamp 95 is vertically movable between its raised position (as shown in FIG. 9) in which the clamp 95 receives book B and lowered trimming position (as shown in FIGS. 10-12) in which the book is positioned in trimming station 61 so that predetermined amounts of the margins of the book may be trimmed from the side and ends of the book so as to produce a book of a predetermined finished size. The clamp 95 is so vertically driven by means of a vertical drive, as generally indicated at 105. This drive comprises a vertical slide body 107 movable (slidable) along a vertical track 109. This drive includes a stepper gearmotor 111, a drive screw 113 driven by motor 111 with the drive screw being threadably coupled to slide body 107 for effecting vertical movement of the slide body and indexing clamp 95 along track 109 so as to effect movement of the indexing clamp between its raised and lowered positions. Because motor 111 is a stepper motor under the control of computer control system CS, it can accurately position book B gripped by clamp 95 within the trimming station so that predetermined margins of the book may be trimmed in a manner as will appear.

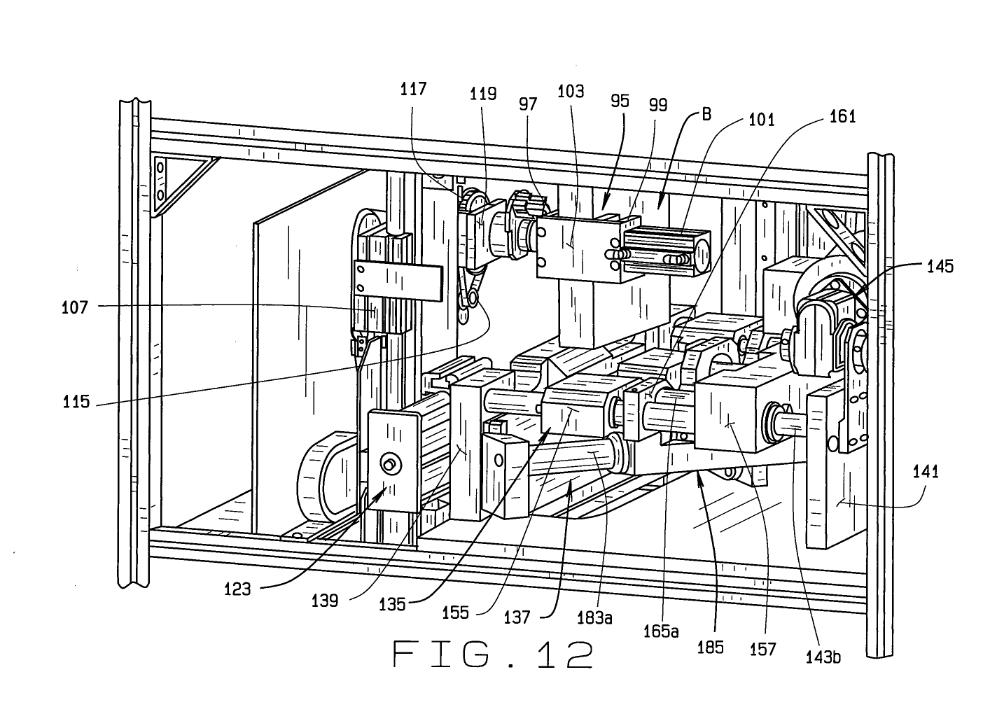

As perhaps best shown in FIG. 12, trim indexing clamp 95 is rotatable about a horizontal axis by means of an indexing motor 115, preferably a stepper motor under control of computer system CS. The motor 115 is carried by vertical slide body 107. The output shaft of motor 115 is coupled to indexing clamp 95 by a timing belt and pulley arrangement, as indicated at 117. The indexing clamp is rotatably mounted in and cantilevered from a rigid bracket 119 carried by the vertical slide body so that upon actuation of motor 115, the indexing clamp 95 may be rotated about the above-noted horizontal axis so as to angularly position the margins of the bound book to be trimmed relative to the trimming station 61 so that the trimmed margins of the book will be “square”, that is the trimmed ends of the book will be substantially perpendicular to the trimmed front side of the book opposite spine S. As indicated at 118a, 118b, and 118c, switches are mounted relative to the horizontal rotational axis of indexing clamp 95 for stopping rotation of the indexing clamp at a first predetermined rotary position so as to position a first side of the book to be trimmed, and then for stopping rotation of the indexing clamp at second rotary position for trimming a second side of the book, and then for stopping rotation of the indexing clamp at a third rotary position for trimming a third side of the book so that two sides of the book (i.e., the top and bottom edges of the finished book) are perpendicular to the spine S and the longitudinal side parallel to the spine.

As generally indicated at 121 in FIGS. 10-12 and 15, a lateral, horizontal drive is provided for moving indexing clamp 95 in lateral, horizontal direction relative along a horizontal track 123 relative to the trimming station 61. Track 123 has spaced horizontal guide rods 125a, 125b on which are mounted a slide carriage 127. A horizontal drive screw 129 is rotatably mounted between guide rods 125a, 125b and is rotatably driven by a stepper motor 130 (See FIG. 12) located on the end of the drive screw opposite from that shown in FIGS. 10-12. This drive screw is threadably coupled to carriage 127. It will be understood that this last-mentioned stepper motor is similar to motor 47 and is under the control of computer control system CS. Thus, index clamp 95, while gripping book B along the spine of the book, may move the book B laterally relative to the trimming station as required so as to accurately position the book within the trimming station 61 so that three edges or sides of the book may be trimmed and so that a finished book of a predetermined finished size is produced. Further, after trimming of the book is complete, the index clamp 95 may be moved laterally so as to deposit the bound and trimmed book in a discharge chute 131 for discharge from apparatus 1.

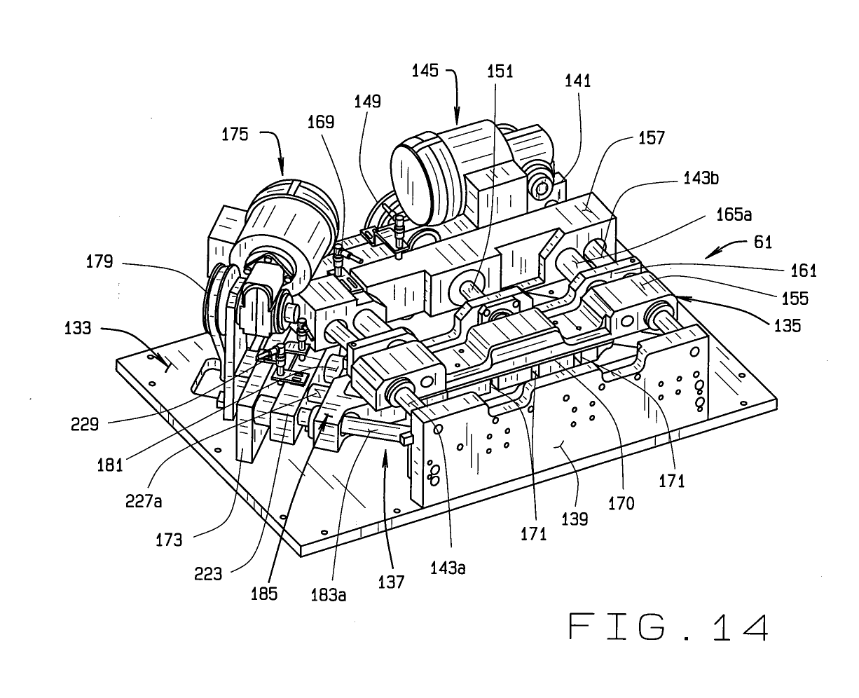

Referring now to FIGS. 14-17, trimming station 61 will be described in more detail. This trimming station 61 is shown to be an electrical-mechanical shear trimmer, as opposed to the hydraulic shear trimmer disclosed in the above noted U.S. Pat. No. 7,104,182. It will be understood that trimmer 61 may be used in place of the prior trimmer to trim the excess margins from one, two, or three sides of the bound book. By providing an electrical-mechanical trimmer, the need for a hydraulic pump, hydraulic lines, servo valves and other hydraulic components has been eliminated. However, those skilled in the art will appreciate that the electrical-mechanical shear trimmer need not be used in conjunction with the improvements to other portions of the apparatus 1, discussed above.

Referring now to FIGS. 14-17, trimming station 61 includes a trimmer frame bed 133 (which is part of frame F) on which the major components of the trimming station are mounted. The trimming station 61 includes a book clamp assembly 135 and a shear assembly 137 mounted on the frame bed. A shear anvil 139 and a rear stationary member 141 are fixedly mounted on the frame bed.

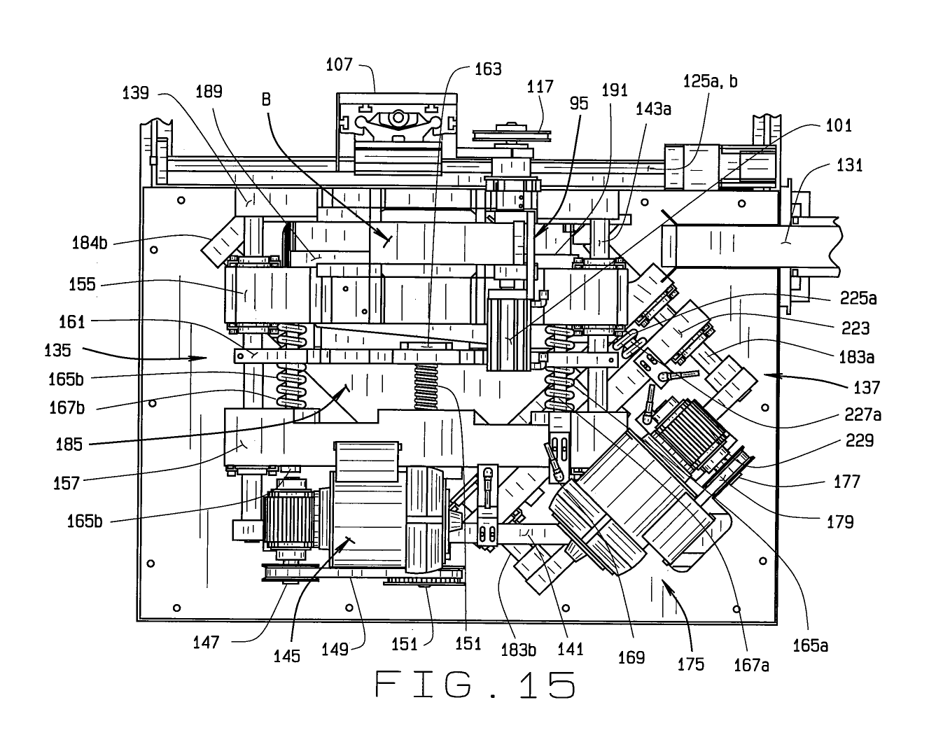

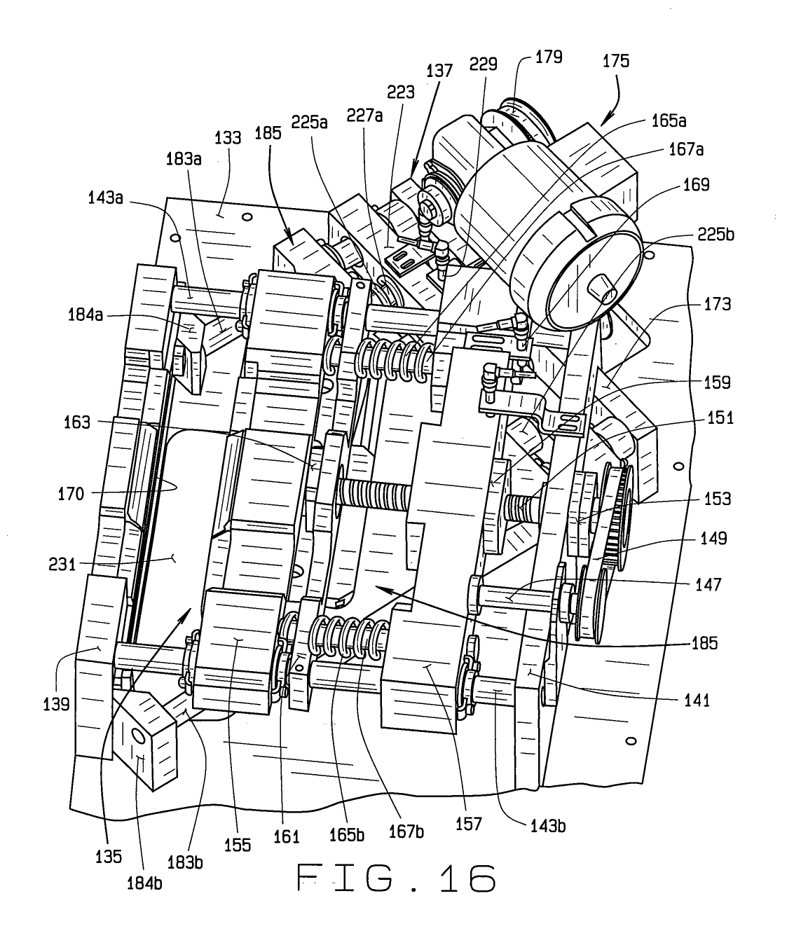

Book clamp assembly 135 is shown to comprise a clamp track, preferably a pair of slide rods 143a, 143b, mounted on and extending between anvil 139 and rear stationary member 141. An electric clamp motor, as generally indicated at 145, is mounted on the rear stationary member and the motor has an output drive shaft 147. Preferably, motor 145 is a reversible gearmotor, such as a model 027-756-442 commercially available from Bison Gear and Engineering Corporation of St. Charles, Ill. This motor is a ¼ horsepower gearmotor has a built-in 20.5:1 speed reducer ratio. The drive shaft 147 of motor 145 drives a clamp timing belt and pulley speed reducing drive 149, which, in turn, drives a clamp drive screw 151 (see FIG. 15). As shown in FIG. 16, a bearing 153 is mounted on stationary rear support member 141 so as to journal one end of drive screw 151. The clamp assembly further includes a movable clamp jaw 155 that is slidably mounted on guide rods 143a, 143b for movement between a retracted position in which a book B of a maximum thickness (e.g., 1,000 pages) may be inserted between fixed anvil 139 and clamp jaw 155, and a clamping position in which a book may be securely clamped between anvil 139 and movable clamp jaw 155 so that the book is firmly held by the clamp while shear assembly 137 trims a predetermined amount from one or more margins of the book. A clamp load member 157 is slidably mounted on slide rods 143a, 143b. A thrust nut 159 is mounted on clamp load member 157 and drive screw 151 threadably engages this thrust nut so that upon turning the drive screw, the clamp load member is caused to move along slide rods 143a, 143b toward and away from anvil 139. Preferably, drive screw 151 is a ball screw and thrust nut 159 is a suitable ball screw nut.

As indicated at 161, a floating yoke is fixedly mounted on slide rods 143a, 143b between clamp jaw 155 and clamp load member 157. Yoke 161 has a bearing 163 at its center that journals the end of drive screw 151. As indicated at 165a, 165b, compression coil springs are interposed between movable clamp jaw 155 and clamp load member 157 and pass through yoke 161, and are not connected to the yoke. Mounted within each spring 165a, 165b is a respective indicating rod 167a, 167b. These indicating rods are cantilevered from the rear face of movable clamp jaw 155 and are free to move within springs 165a, 165b.

With clamp jaw 155 in its retracted position, the rear ends of indicating rods 167a, 167b are substantially flush with the rear face of clamp load member 157. Upon energization of clamp motor 145 to rotate drive screw 151 in a direction to move clamp load member 157 toward anvil 139, springs 165a, 165b will initially move clamp jaw 155 toward anvil 139 substantially without compressing the springs until the clamp jaw engages book B clamped in position by clamp assembly 135. Continued operation of motor 145 will begin to compress springs 165a, 165b and will result in “lost motion” between clamp jaw 155 and clamp load member 157. That is, because further movement of clamp jaw 155 is prevented by book B, as clamp motor 145 continues to operate, member 157 will continue to move toward the clamp jaw and thus to compress clamp springs 165a, 165b. With further movement of the clamp jaw 155 prevented by book B, the continued movement of load member 157 causes the load member to move relative to the now stationary indicating rods 167a, 167b carried by the clamp jaw and the rear ends of the indicating rods will extend out holes in the load member 157 beyond its rear face. As indicated at 169, a transducer (preferably a proximity switch) is mounted on movable load member 157 to sense when indicating rod 167a has moved a predetermined distance relative to load member 157 so as to generate a signal that the springs 165a, 165b have been compressed the predetermined amount and that a predetermined clamping load has been applied to book B. Once this predetermined clamping load (e.g., about 2,000 pounds or 909 kg.) has been applied to book B, the signal generated by proximity switch 169 terminates operation of clamping motor 145. Because the clamp motor is a gearmotor, the backload applied to the clamp on motor 145 by the clamped book is not sufficient to back drive the motor and thus clamp assembly remains locked in place and the desired the clamping load is maintained on the book upon de-energization of the motor.

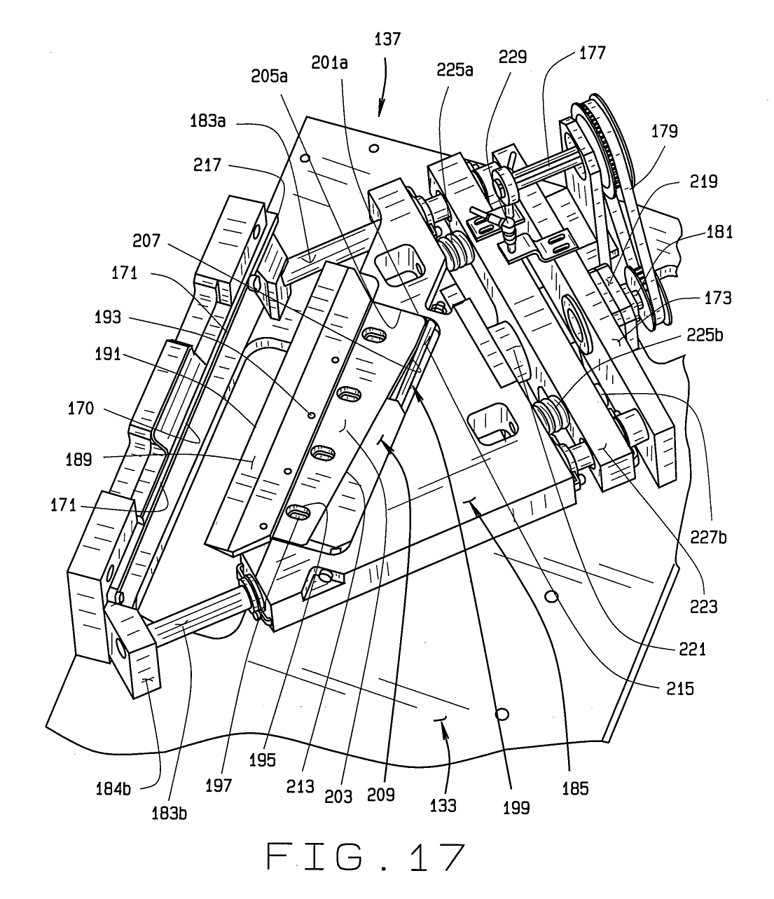

As perhaps best shown in FIG. 15, the fixed clamp jaw 97 of indexing clamp 95 is fixedly held in the same vertical plane as the inside face of anvil 135. In that manner, as indexing clamp moves the book vertically, laterally and rotationally to position the various edges of the book within clamp assembly 135, the back face of the book is properly positioned with respect to anvil 139. As indicated at 170, the inside face of anvil 135 and the outer face of clamp jaw 155 each have a clamp bar mounted thereon for applying a concentrated clamping force to book B during trimming to better hold the pages of the book against shifting as a margin of the book is trimmed. As indicated at 171 in FIG. 17, grooves are provided in clamp bars 170 which are positioned to receive the spine S of the book B when the top and bottom ends of the book are trimmed with the spine extending vertically. These grooves 171 prevent damage to the bound book that may result if the spine of the book is crushed by the clamp bars 170 during trimming. It will be understood that with a book B being gripped by indexing clamp 95 in a known position along the spine of the book, the grooves will receive the spine when the top or bottom ends of the book are trimmed.

As noted, trimming station 61 further includes an electrically powered shear assembly 137 for shearing predetermined amounts from one or more sides a book B held in the clamp assembly 135. This shear assembly includes a fixed or stationary shear mounting member 173 mounted to trimmer frame bed 133 and spaced from anvil 139. A shear electric motor, as generally indicated at 175, is mounted on mounting member 173. Motor 175 is similar to clamp motor 145 heretofore discussed. The motor has a drive shaft 177, which drives a timing belt and pulley drive 179, which in turn drives a shear drive screw 181 (see FIG. 17).

As indicated at 183a, 183b, a shear track, preferably a pair of spaced slide rods, extends between anvil 139 and the rear stationary shear member 173. As best shown in FIG. 15, the slide rods 183a, 183b are positioned on the trimmer bed 133 at an angle of about 45° relative to the stationary anvil 139. To accommodate this angular mounting of the slide rods relative the anvil 139, the anvil has angled tabs 184a, 184b extending therefrom to which the ends of slide rods 183a, 183b are mounted proximate anvil 139. Of course, tabs 183a, 183b are solidly attached to frame bed 133. Rear stationary member 173 is also fixedly mounted to frame bed 133 at an angle of about 45° relative to anvil 139. A shear blade carrier, as generally indicated at 185, is slidable on slide rods 183a, 183b between a retracted position in which a book B may be positioned within the open clamp assembly 135 and a shearing position in which a margin of the book may be trimmed to a predetermined dimension.

As best shown in FIG. 17, shear blade carrier 185 includes a shear blade assembly, as generally indicated at 187. The shear blade assembly includes a shear blade 189, preferably a carbide blade; with the blade have an elongate sharp shear edge 191. The shear blade assembly 187 is removably mounted in shear blade carrier 185 and is held in place in a manner as will be described. The shear blade 189 is removably secured to the shear blade assembly 187 by bolts 193 (as shown in FIG. 17). The shear blade assembly 187 has a plurality (e.g., four) of elongate slots 195 that extend generally perpendicular to blade edge 191. These elongate slots in the blade assembly cooperate with mating elongate slots 197 in the blade carrier 185 and receive bolts (not shown). These slots and the bolts permit the shear blade assembly 187 to be precisely positioned within the shear blade carrier 185 so that the cutting edge 191 of blade 189 uniformly contacts the book along the width of the book side to be sheared. The blade is firmly held in place relative to blade carrier 185 when the bolts (again, not shown) in slots 195, 197 are tightened.

Referring to FIG. 17, the blade assembly 187 is received in a rectangular recess, as generally indicated at 199, formed in blade carrier 185 with the opposite sides of the recess extending generally perpendicular to blade edge 191 being indicated at 201a, 201b. Blade assembly 187 further has a body 203, which has sides 205a, 205b that are slidably mated in a close sliding fit with sides 201a, 201b of recess 199. Blade assembly body 203 also has an inclined rear side 207. A blade adjustment cam, as generally indicated at 209, is slidably mounted within recess 199 between the rear side 207 of the blade body 203 and a rear edge 211 of recess 199 in blade carrier 185. Cam 209 has a sloped or inclined cam face 213 that is in slidable engagement with the inclined rear side 207 of blade body 203. Cam 209 is adjustably movable within recess 199 by means of an adjustment screw 215. That is, by operation of screw 215 in a direction to move cam 209 toward side 201a, the cam forces blade body 203 outwardly within recess 199. In this manner, blade edge 191 may be precisely moved within recess 199 so as to adjust the position of the cutting edge 191 of blade 189 and for securely holding the blade in its adjusted position during shearing of the book, even though high loads are applied to the blade. As indicated at 217 in FIG. 17, a compressible blade engagement member is carried by anvil 139. This compressible member 217 is so positioned that as the blade edge 191 shears through book B, the shear edge bears into the compressible member so as to cushion the blade and to prevent damage to and dulling of the blade. It will be appreciated that the compressible member 217 may be of a suitable material, such as polyethylene, that will not be damaged by blade edge 191 as the shear blade shears through a book.

A bearing 219 is mounted on rear stationary member 173 so as to journal shear drive screw 181 with respect to the rear member. A drive screw nut and thrust bearing 221 is secured to the middle of an elongate intermediate shear load member 223, which is slidably mounted on slide rods 183a, 183b. This nut is threadably connected to drive screw 181. Preferably, drive screw 181 is a ball screw and nut and thrust bearing 221 is a ball screw nut.

As indicated at 225a, 225b in FIGS. 16 and 17, shear compression springs are interposed between blade carrier 185 and intermediate shear load member 223. Indicator rods 227a, 227b are carried by blade carrier 185 and are mounted to extend within the shear springs. The indicator rods are not connected to the springs and the ends of indicator rods extend through intermediate load member 223 and are free to move with respect to this load member.

Upon energization of shear motor 175 so as to move shear blade 189 from its retracted position so as to shear a book B positioned in and held by clamp assembly 135, shear drive screw 181 will move intermediate member 223 along slide rods 183a, 183b. The shear springs 225a, 225b interposed between intermediate member 223 and carrier 185 are sufficiently stiff so as to move blade 189 into contact with book B substantially without compressing the shear springs. As the edge 191 of the blade begins to shear the book, continued operation of the shear motor 175 will continue to move both the intermediate member and the blade carrier, and thus to increase the a shear load applied to the blade by shear springs 225a, 225b, thus compressing these springs. As the blade edge 191 shears through the book cover C and contacts the compressible anvil 217, continued operation of shear motor 175 will cause the intermediate member 223 to continue to compress shear springs 225a, 225b with little or no further movement of the blade carrier. This then constitutes a lost motion connection between the drive screw 181 and the carrier 185, which in turn causes indicator rods 227a, 227b to extend out the back side of the intermediate member. As indicated at 229, a transducer (again, preferably a proximity switch) is mounted on intermediate member 223 and is so positioned as to sense when the end of indicator rod 227a moves a predetermined amount relative to the intermediate member thus indicating that the edge of the shear blade 189 has sheared through the book and has encountered compressible anvil 217. It will be understood that the distance that the indicating rods need move relative to load member 223 after blade 189 engages the compressible anvil member 217 to trip switch 229 may be a relatively short distance (e.g., about 0.025 to about 0.050 inches or more). Upon proximity switch 229 being so tripped, the switch causes shear motor 175 to reverse direction and to cause the blade to retract. As shown best in FIGS. 16 and 17, frame bed 133 has an opening 231 therein below where book B is trimmed so that the waste paper trimmed from the book may fall into a suitable trash receptacle (not shown).

U.S. patent applications ______ and ______, identified by attorney docket numbers MARJ D432 and MARJ D468, filed contemporaneously with this present application are herein incorporated by reference in their entirety.

In operation, a POD book to be printed is selected by a customer or by another person operating apparatus 1. It will be understood that a library of POD books is available, which library may contain a large number of books. The books in this library may be of different sizes and, of course, the books will have different number of pages. Once a book is selected, the data corresponding to the text of the book is sent to text page printer 3 and the data corresponding to the cover for the selected book is sent to cover printer 5. These printers begin to print the book block BB and cover C for the selected book. A wide variety of sizes of books may be printed on demand on a standard size paper, such as 8½×11. The text for the text pages of the book is centered heightwise on the page and is printed a prescribed distance from one major (long) edge of each text page that this one major edge will constitute the spine S of the book block BB. When the book is printed, this prescribed distance from this one edge will constitute the gutter of the book. This in turn allows the control system CS to “know” what margins of the bound book must be trimmed from the sides of the book B in order to produce a finished book of a predetermined size. Other data corresponding to the book to be printed (e.g., the number of pages in the book, the finished trim size along each edge of the book, and the like) may be sent to computer control system CS for purposes as will appear, below.

With accumulator 11 in its first position, as shown in FIG. 2, pages printed by the page printer 3 are preferably de-curled by de-curler 13 and are deposited on the accumulator bed 15. As each page or small group of pages is deposited on bed 15, page tappers 51 and 53 are actuated so as to insure that one edge of each page (or small group of pages) of the book block being formed is in firm engagement with stop plate 21 and with side 19 thus positioning the book block in a known position within the accumulator/fixture 11. When page printer 3 has completed printing all of the pages of the book block and when all of the pages have been accumulated in the accumulator 7, accumulator clamp 29 is actuated by means clamp cylinder 37 so as to firmly clamp the book block in position on the accumulator bed 15. Then, cylinder 43 is actuated so as to pivot stop plate 21 to its retracted position clear of the spine S of the book block. Then, accumulator pivot cylinder 27 is actuated so as to pivot accumulator frame 17 from its inclined position (as shown in FIGS. 2-4) to its vertical position (as shown in FIG. 5). As previously noted, when the stop plate 21 is moved to its retracted position and when the book block is clamped in the accumulator, the accumulator bed 15 and the clamp 29 are positioned in spaced relation to the spine S such that about ⅜ inches (9.5 mm.) of the book block proximate the spine is exposed.

With the adhesive application station 57 in its ready position (that is, at the right-hand end of track 76, as shown in FIG. 6), motor 47 is energized so as to move the accumulator clamp 29 and the book block BB held by thereby downwardly from the position shown in FIG. 4 to the position shown in FIG. 7 in which the spine S of the book block BB held by clamp 29 is positioned just above the level of adhesive application wheel 71 with a space or gap G between spine S and the upper surface of wheel 71. As previously noted, when a POD book is ordered to be produced by apparatus 1, the number of pages in the book block for that book is made known to the PLC computer controller CS. The computer controller positions the spine S in proper position with respect to the top surface of wheel 71 in accordance with the relationship AT=b+mX, as previously described. This, in turn, adjusts gap G so as to vary the amount (thickness) of the adhesive coating applied to the spine in relation to the thickness (based on either the number of pages in the book block, or based on the actual measured thickness of the book block, as measured by laser measuring sensor 82 or the like). Motor 73 is energized so as to rotate wheel 71 such that the peripheral surface of the wheel is coated with adhesive, as previously described.

Motor 79 is then energized so as to move spine roughener 63 and adhesive application wheel 71 relative to the stationary book block spine so that the roughener blades 65 will scrap along the spine so as to roughen the edges of the paper sheets comprising the spine. The wheel 71 will apply a desired amount (thickness) of the adhesive to the spine in the manner heretofore described. Upon the adhesive application station 57 to its position, as shown in FIG. 6, in which the adhesive pot 67 is clear of the spine of the book block, motor 47 is further energized so as to move the book block downwardly along work path WP from the adhesive application station 57 to the binding station 59.

As noted, cover C is printed by cover printer 5. Upon completion of printing of the cover, the cover is conveyed from the cover printer to binding station 59 by means of cover conveyor 83, which has rollers 84 controlled by the computer controller CS. It will be appreciated that because a POD book to be printed and bound by apparatus 1 may have a different number of pages in its book block than the books previously or subsequently printed, the cover C may have a different width of the cover spine (not shown) so that the cover may be wrapped around the spine S of the book block and so that the cover will be properly positioned on the front and back of its respective book block. Because this cover spine area of each consecutive cover may be different from the previously printed cover, it is necessary that each cover be accurately positioned on the binding station or table 59. This is accomplished by the computer control system controlling operation or conveyor rollers 84 in accordance with data received by the computer control system regarding the book being printed and bound. It will be understood that the cover may be so positioned on the binding table while the book block BB is being printed by page printer 3.

With the cover C properly positioned on binding table 59 and with binding bed 91 in its operative position beneath the opening between binding clamp jaws 87a, 87b (as shown in FIG. 8), motor 47 is energized so as to move book block BB down so that the spine S with the adhesive applied thereto is brought into contact with the predetermined center spine area on the inside face of cover C. Continued downward movement of the spine forces the cover to bear against the binding bed 91 so as to insure that there is good adhesive binding contact between the spine and the cover. Then, binding clamp cylinders 89a, 89b are actuated so as to forcibly close binding clamp jaws 87a, 87b and so as to clamp the cover to the sides of the book block just above the level of spine S. These clamping jaws remain in clamping engagement with the cover and the book block for a time sufficient (e.g., about 4-8 seconds, depending on the characteristics and temperature of the adhesive) for adhesive to cool and for the cover to become adhesively bound to the book block.

While the now bound book B is still gripped by binding jaws 87a, 87b, accumulator clamp cylinder 37 is actuated so as to release the grip of accumulator clamp 29 on the book block BB adjacent spine S (as shown in FIG. 7). Then motor 47 is energized so as to move the accumulator clamp upwardly to a position, as shown in FIG. 9, where the accumulator clamp cylinder 37 is actuated so that the accumulator clamp 29 re-grips the book block adjacent the edge of the book block opposite spine S. It will be appreciated that because the position and dimensions of the book block was “known” to the computer control system when the book block was initially clamped in the accumulator clamp 29, and because the book block remains clamped by binding clamp 85, the position of the book block remains “known” to the computer control system when the book block is re-gripped, as shown in FIG. 9.

After the book block has been so re-gripped, cylinder 93 is actuated so as to retract binding bed 91 beneath binding clamp jaws 87a, 87b. Then cylinders 89a, 89b are actuated to release binding clamp 85 from the now bound book B. Motor 47 is actuated so as to move the bound book downwardly between the now open clamp jaws 87a, 87b and the spine of the bound book is inserted in indexing clamp 95, as shown in FIG. 9. Cylinder 101 is actuated so as to firmly clamp the bound book B in indexing clamp 95. In this manner, the position of the bound book relative to the indexing clamp remains known to the computer control system. Because the amount of the margins of the bound book are known to the computer control system CS and because the position of the bound book is in a known position in indexing clamp 95, the computer control system may operate motors 111, 115, and 130 so as to accurately position the ends and side of the bound book in clamp assembly 135 so that shear trimmer 135 may trim predetermined trim amounts of the margins of the book so as to produced a finished book of a predetermined size.

With trim clamp assembly 137 in its retracted or open position (as shown in FIGS. 13 and 15), indexing clamp 95 is rotated by motor 115 so as to position a first end or side of the bound book at the proper angle with respect to trim blade 181 so that the above-noted predetermined amount may be trimmed from that side upon actuation of shear assembly 139. With the book now in the proper angle for trimming, motor 111 is energized so as to adjust the indexing clamp to the desired vertical position relative to shear blade 189 and stepper motor 130 is energized to move the indexing clamp laterally along track 123 so as to properly position book B in the shear.

With the book so positioned, clamp motor 145 is energized to move the clamping jaw 155 from its retracted position to its clamping position (as shown in FIG. 15) in which the book is firmly held between the fixed anvil 135 and the clamping jaw 155. As noted, the compression clamping springs 165a, 165b exert a clamping force on clamping jaw 155 upon actuation of clamping motor 145. The clamping assembly 135 has a “lost motion” connection between the springs 165a, 165b and the clamping jaw 155 such that upon the clamping jaw engaging the book B to be clamped, the book prevents further movement of the clamping jaw toward the book. Continued operation of clamping motor 145 will continue to compress springs 165a, 165b so as to apply a desired maximum clamping force to the clamping jaw (e.g., about 2,000 pounds or about 909 kg.). When this desired clamping force has been applied, the lost motion connection between clamp jaw 155, which is held stationary by the book, and the continue motion of clamp load member 157 will cause indicator rod 167a to mover relative to clamp load member 157 and to thus trip proximity switch 169 indicating that the desired clamping force has been applied to the book. The proximity switch 169 thus generates a signal so as to de-energize motor 145. Because motor 145 is preferably a gearmotor, when the motor is de-energized the gearmotor will effectively lock the clamp assembly in its clamped position and to thus maintain the desired maximum clamping force on the book B.

Upon proper clamping of book B in clamp assembly 135, shear motor 175 is energized so as to move the shear blade carrier 185 and blade assembly 187 toward book B. As the cutting edge 191 of blade 189 engages book B, continued operation of trim motor 175 exerts a sufficient force on the blade to shear book B. Continued operation of the shear motor will cause the blade 189 to shear through the book. Upon the cutting edge 185 shearing completely through the book and coming into contact with the compressible blade bearing member 217, the amount of force exerted by the motor will sharply increase to about 2,500 pounds (about 1135 kg.). This increased force causes the lost motion connection with compression shear springs 225a, 225b move indicator rod 227a a sufficient distance to trip proximity switch 229 and to thus reverse motor 175 so as to retract the shear blade.

Upon the completion of trimming of one edge of the book and upon retraction of blade 189, clamp motor 145 is energized to retract clamp jaw 155 thus releasing book B from the clamp. Then, motor 111 is energized so as to vertically move book B up out of clamp assembly 137, and then motor 115 is energized to as to rotate indexing clamp 95 and the book held thereby to its next angular position which that the next side of the book to be trimmed is in a horizontal position parallel to trim blade 181. Then motor 111 is energized so as to move the book down within the clamp assembly such that the next side of the book is positioned relative to the level of trim blade 189 so that the predetermined amount of this next side of the book may be trimmed from the book. The clamp assembly 135 and the shear assembly 137 are then actuated in the manner previously described so as to trim this next side of the book. This process is repeated so that the third side or edge of the book B may be trimmed a predetermined amount.

It will be understood that in regard to clamp assembly 135 and shear assembly 137, the drives for these assemblies that utilize no fluid components (e.g., hydraulic cylinders, hydraulic pumps, and hydraulic valves and lines) to apply the clamping forces and the shear forces necessary to clamp and shear a book B are referred to as “mechanical” While in such “mechanical” drives preferably use electric motors, such as motors 145 and 175, other motors, such as a fluid motor could be used, but such fluid motors would require a source of fluid pressure (air or hydraulic) and associated fluid components and are thus not believed to be as suitable as the mechanical drives for the clamp and the shear herein described.

After trimming of the book is complete, the book is released from clamp assembly 135 and raised vertically clear of the clamp assembly. Then, motor 130 is energized so as to move the indexing clamp 95 and the now trimmed book B laterally toward book discharge chute 131. With the book in register with the discharge chute, indexing clamp cylinder 101 is operated to release the book and the finished book is dropped into the discharge chute thus completing the printing, trimming and binding of book B.

When the accumulator clamp 29 hands off the bound book B to indexing clamp 95, as described above, it will be understood that the accumulator may be returned to its first, inclined position, as shown in FIG. 2, and the printing of the next POD book may be commenced even while the trimming of the first produced book is occurring. Also, the cover for the next book may be commenced.

Throughout this disclosure, numerous fluid cylinders, such as indicated at 27, 37, 43, 89a and b, 93, and 101, preferably pneumatic or air cylinders, but those skilled in the art will recognize that these cylinders could be replaced by other types of actuators that perform the functions of these cylinders. For example, many of these cylinders could be replaced by a linear actuator comprising and electric motor and a lead screw. Further, those skilled in the art will understand that terms such as “perpendicular” and “parallel” do not mean that certain relationships must be perfectly perpendicular or parallel, but rather are generally perpendicular or parallel. It will be further understood that upon trimming the major and the minor sides of said book that the order in which the sides are trimmed is not an important part of this disclosure.

As various changes could be made in the above constructions without departing from the broad scope of the invention, it is intended that all matter contained in the above description or shown in the accompanying drawings shall be interpreted as illustrative and not in a limiting sense.

1. A mechanical shear for trimming one or more sides of a perfect bound book to predetermined dimensions, said book comprising a book block including a plurality of sheets of paper, one side of said book block constituting a spine, said book having a cover adhesively bound to said spine with a front cover disposed against one face of said book block, with a back cover disposed against another face of said book block, and with a spine portion of said cover disposed against the spine of said book block, said book having a first side parallel to said spine, and second and third sides perpendicular to said spine and to said first side at opposite ends of said book, said shear comprising:
a. an indexing clamp holding said book along said spine of said book with the position of said book relative to said indexing clamp being established so that the margins of said book along said first, second and third sides to be trimmed may be determined;
b. a book clamp for holding said book while a margin of the book is trimmed;
c. said book clamp comprising a stationary anvil that supports one face of said book to be trimmed, and a book clamp member that clamps said book to be trimmed in position against said anvil during trimming of said book;
d. said book clamp member being movable toward and away from said anvil between a retracted position in which said book may be positioned in said book clamp and a clamping position in which said book is clamped within said book clamp so as to hold said book while said book is trimmed;
e. a shear blade movable between a retracted position in which said blade is clear of a book positioned in said book clamp and a trimming position in which said blade engages said book so as to trim one side of said book;
f. said indexing clamp being operable so as to position one margin of said book relative to said shear blade so that upon actuation of said blade to move from its retracted position to its trimming position so as to trim said book along said one margin;
g. an mechanical clamp drive for effecting clamping of said book within said book clamp; and
h. a mechanical shear drive for effecting movement of said blade between its retracted and trimming positions.

2. A shear as set forth in claim 1 wherein said mechanical clamp drive comprises a rear stationary member and a clamp track supported by said anvil and by said rear stationary member and extending therebetween, said clamp member being mounted on said clamp track for movement toward and away from said anvil between its said retracted and clamping positions.

3. A shear as set forth in claim 2 wherein said mechanical clamp drive further includes a clamp motor and a clamp drive screw rotary driven by said clamp motor, said clamp drive screw being operatively coupled to said clamp member for effecting movement of said clamp member between its said retracted and clamping positions upon operation of said motor.

4. A shear as set forth in claim 3 wherein said mechanical clamp drive further includes a clamp load member mounted on said clamp track between said clamp member and said rear stationary member, said clamp load member being driven along said clamp track by said clamp drive screw.

5. A shear as set forth in claim 4 wherein said mechanical clamp drive further includes at least one clamp spring interposed between said clamping member and said clamp load member such that upon operation of said clamp motor in one direction, said clamp load member via said spring moves said clamp member toward its clamping position.

6. A shear as set forth in claim 5 wherein as said clamping member engages a book positioned between said anvil and said clamping member said book effectively prevents further movement of said clamping member toward said anvil, and wherein upon continued operation of said clamp motor in said one direction causes after said clamping member has engaged said book said clamp spring is loaded until said clamp spring has applied a predetermined clamping load to said clamp member at which time operation of said clamp motor is terminated thereby effectively maintaining said predetermined clamping load on said book.

7. A shear as set forth in claim 6 wherein said mechanical clamp drive further includes at least one indicator member carried by said clamp member such that upon said clamp member engaging said book continued operation of said clamp motor in said one direction causes differential movement between said indicator member and said clamp load member, and wherein said shear further includes a transducer responsive to a predetermined amount of said differential movement so as to generate a signal operable to terminate operation of said motor.

8. A shear as set forth in claim 7 wherein said clamp spring includes a pair of compression clamp springs interposed between said clamp member and said clamp load member.

9. A shear as set forth in claim 7 further wherein said clamp motor is an electrically powered gearmotor wherein upon termination of operation of said motor said gearmotor is effectively locked in position so that said gearmotor maintains a predetermined clamping load on said book.

10. A shear as set forth in claim 7 wherein said transducer is a proximity switch that senses said indicator member upon said predetermined clamping load being applied to said book.

11. A shear as set forth in claim 1 wherein said mechanical blade drive further includes a rear stationary member spaced from said anvil, and a shear track mounted to said anvil and to said rear stationary member and extending therebetween, said shear blade being slidably mounted on said shear track for movement between its retraced and shearing positions.

12. A shear as set forth in claim 11 further including a blade carrier in which said shear blade is mounted, and wherein said blade carrier is movable along said shear slide track.

13. A shear as set forth in claim 11 further comprising a shear load member mounted on said shear track between said blade and said rear stationary member.

14. A shear as set forth in claim 13 further including at least one shear spring interposed between said shear blade and said shear load member such that upon operation of said shear motor in one direction, said shear load member via said shear spring moves said shear blade toward its shearing position.

15. A shear as set forth in claim 13 further comprising a shear motor and a shear drive screw rotary driven by said shear motor, said shear drive screw being operatively coupled to said shear load member so that upon operation of said shear motor in one direction or the other said shear load member and said shear blade are driven along said shear track toward and away from a book held by said book clamp.

16. A shear as set forth in claim 15 further comprising at least one shear spring interposed between said blade and said shear load member so that upon operation of said motor in one direction said shear load member via said shear spring causes said blade to move toward said book.

17. A shear as set forth in claim 16 wherein as said shear load member moves said blade along said shear track and as said shear blade initially contacts said book continued movement of said shear motor in said one direction causes said load member to load said shear spring so as to cause said shear blade to shear said book.

18. A shear as set forth in claim 17 wherein said anvil has a compressible member engageable by said shear blade as said shear blade shears through said book.

19. A shear as set forth in claim 18 further comprising an indicator member carried by said shear blade such that upon said shear blade shearing through said book and engaging said compressible member continued movement of said shear blade is effectively stopped, and wherein continued operation of said shear motor in said one direction causes an increase in load on said spring without substantial corresponding movement of said shear blade which in turn effects differential movement between said shear load member and said indicator member, and wherein a transducer is positioned to be responsive to a predetermined amount of said differential movement for terminating operation of said shear motor in said one direction.

20. A shear as set forth in claim 19 wherein upon said transducer terminating operation of said motor in said one direction, operation of said shear motor is reversed so that said blade is moved toward its retracted position.

21. A shear as set forth in claim 19 wherein said transducer is a proximity switch.

22. A shear as set forth in claim 14 wherein said shear track comprises a pair of spaced slide rods, and wherein said shear spring comprises a pair of spaced compression springs interposed between said shear load member and said blade.

23. A shear as set forth in claim 12 wherein said shear blade is adjustably mounted within a blade carrier, said blade carrier having a recess therein for receiving said shear blade, said recess having spaced parallel sides extending toward said anvil and a rear side, said shear blade having sides that have a close sliding fit within said recess so that the sides of said shear blade and the sides of said recess cooperate to effectively prevent side-to-side movement of said blade relative to said blade carrier.

24. A shear as set forth in claim 23 wherein said shear blade has a rear side, and wherein said blade carrier has a shear blade adjustment cam disposed in said recess between said rear side of said shear blade and said rear side of said recess whereupon effecting lateral movement of said cam in one lateral direction within said recess, said shear blade is moved outwardly of said recess in a direction generally parallel to the sides of said recess.

25. A shear as set forth in claim 24 wherein with the rear side of said shear blade being in engagement with one side of said cam, with the other side of said cam in engagement with said rear side of said recess, and with at least two of these last-said sides being inclined with respect to the direction of said lateral movement of said cam within said recess for cammingly forcing said blade outwardly of said shear blade carrier upon effecting lateral movement of said cam in said one lateral direction within said recess.

26. A shear as set forth in claim 23 wherein said shear blade has an inclined rear side, and wherein said blade carrier has a blade adjustment cam disposed in said recess between said inclined side of said blade and said rear side of said recess, said cam enabling adjustable movement of said blade toward and away from blade carrier so as to insure that said blade properly engages said book, said cam having an inclined cam face engageable with said inclined rear side of said blade and a threaded adjustment for moving said cam within said recess toward one side thereof so that said inclined cam face forces said shear blade outwardly of said blade carrier.

27. A shear as set forth in claim 12 wherein said shear slide track is disposed at an angle relative to said anvil so that as said blade shears through said book said blade is moved at said angle with respect to said book.

28. A shear as set forth in claim 27 wherein said angle is about 45°.

29. Apparatus for trimming perfect bound books comprising a clamping assembly, a shearing assembly, and a fixed anvil, said clamping assembly including a clamp member movable along a clamp track toward and away from said anvil between a retracted position in which a book may be placed between said anvil and said clamp member and a clamping position in which said book is clamped between said anvil and said clamp member, said shear assembly having a shear blade movable along a shear track toward and away from said anvil between a retracted position in which said shear blade is clear of said book held by said clamping assembly and a shearing position in which said shear blade shears through said book, a clamp load member mounted on said clamp track for movement therealong, a shear load member mounted on said shear track for movement therealong, said clamp assembly having a clamp electric motor driving a clamp linear actuator operatively coupled to said clamp load member, said shear assembly having a shear electric motor driving a shear linear actuator operatively coupled to said shear load member, at least one clamp spring interposed between said clamp load member and said clamp member such that as said clamp member engages said book continued operation of said clamp motor to drive said clamp member toward said book causes said clamp spring to load so as to apply a clamping load to said book and to then effect in differential movement between said clamp load member and said clamp member which in turn effects the de-energization of said clamp motor thereby to substantially lock said clamp member in its said clamped position so as to hold said book while it is trimmed, at least one shear spring interposed between said shear load member and said shear blade such that as said shear blade shears through said book and engages said anvil continued operation of said shear motor to drive said shear member toward said anvil causes said shear spring to load and to effect differential movement between said shear blade and said shear load member which effects reversal of said shear motor so as to retract said shear blade.

30. A method of clamping a perfect bound book in position for being trimmed, said book comprising a book block having a plurality of sheets of generally rectangular form and said book block and said book having two major sides and two minor sides with one of the major sides of the book block constituting a spine with the other major side being opposite said spine and with said minor sides being at opposite ends of said spine and said other major side, said book further having a cover wrapped around said spine and being adhesively bound to said spine, said book having excess margins along said one major sides and along said minor sides that are to be trimmed so as to result in a finished book of a predetermined finished size, said method comprising the steps of:
a. positioning said book in a clamp in a predetermined position relative to a selectively actuable shear blade so that a margin along one side of said book may be trimmed by said shear blade, said clamp having a clamp member movable along a clamp track between a retracted position in which said book may be inserted in and removed from said clamp and a clamping position in which said clamp firmly clamps said book to a fixed anvil, said clamp further having a clamp load member, a clamp motor, a linear actuator drive driven by said motor for moving said clamp load member along said clamp track between its said retracted and clamping positions, wherein said clamp load member is resiliently operatively coupled to said clamp;
b. initiating operation of said clamp motor for moving said clamp load member and said clamp member along said clamp track from said retracted position and said clamping position;
c. upon said clamp member engaging said book and clamping said book in said clamp and upon said clamp load member applying a predetermined clamping load to said clamp member, terminating operation of said clamp motor; and

31. The method of claim 30 wherein, as said clamp load member applies said predetermined clamping load to said clamp member, said method further comprises the step of:
d. effecting differential movement of a predetermined distance between said clamp member and said clamp load member as said predetermined clamping load is applied to said book; and
e. terminating operation of said clamp motor in response to sensing a predetermined amount of said differential movement corresponding to said predetermined clamping load.

32. The method of claim 31 further comprising the step of:
f. terminating operation of said clamp motor thereby locking said clamp in its clamping position.

33. The method of claim 32 wherein, after a first side of said book has been trimmed, said method further comprising the steps of:
g. initiating operation of said clamp motor to move said clamp toward its retracted position thereby to release said book from said clamp;
h. turning said book so that a second side of said book is positioned in said clamp for trimming of said second side; and
i. clamping said book in said clamp in the manner described above.

34. The method of claim 33 wherein, after a second side of said book has been trimmed, said method further comprises the steps of:
j. initiating operation of said motor to move said clamp toward its retracted position thereby to release said book from said clamp;
k. turning said book so that a third side of said book is positioned in said clamp for trimming of said third side; and
l. clamping said book in said clamp in the manner described above.

35. A method of shearing a perfect bound book, the latter comprising a book block having a plurality of sheets of generally rectangular form and said book block and said book having two major sides and two minor sides with one of the major sides of the book block and of the book constituting a spine with the other major side being opposite said spine and with said minor sides being at opposite ends of said spine and said other major side, said book further having a cover wrapped around said spine and being adhesively bound to said spine, said book having excess margins along said one major side and along said minor sides that are to be trimmed so as to result in a finished book of a predetermined finished size, said method comprises the steps of:
a. positioning said book in a clamp in a predetermined position relative to a selectively actuable shear blade for having a predetermined margin trimmed from one of said sides of said book upon actuation of said shear blade;
b. clamping said book within said clamp in said predetermined position;
c. moving said shear blade along a shear track between a retracted position in which said book may be inserted in and removed from said clamp and a shearing position in which said shear blade shears through said book block and said cover so that said predetermined margin is trimmed from said book, a shear load member movable along said shear track, a shear motor, a linear actuator drive driven by said shear motor for moving said shear blade between its said retracted and clamping position, and wherein said shear load member is resiliently operatively coupled to said shear blade;
d. initiating operation of said shear motor for moving said shear load member and said shear blade from its said retracted position to its said shearing position; and
e. upon said shear blade shearing through said book and engaging an anvil which substantially prevents further movement of said blade, reversing operation of said shear motor and moving said shear blade toward its retracted position.

36. The method of claim 35 wherein, upon said shear blade shearing through said book and contacting said anvil, said method further comprises the step of:
e. effecting differential movement of a predetermined distance between said shear blade and said shear load member thereby to cause reversal of said shear motor.

37. The method of claim 35 further comprising the step of;
e. moving said shear blade at an angle of about 45° relative to said book as said blade shears said book.

38. The method of claim 35 wherein at least one spring is interposed between said shear load member and said shear blade, said method further comprising the steps of:
e. upon said shear blade shearing through said book and upon said shear blade engaging said anvil, preventing further movement of said shear blade relative to said anvil;
f. resiliently cushioning relative movement of shear load member and shear blade;
g. continuing to drive said shear load member toward said shear blade thereby to cause said differential motion between said shear load member and said shear blade; and
h. terminating operation of said shear motor in said one direction upon sensing said differential movement of a predetermined amount.
